(19) United States
(12) Patent Application Publication
(10) Pub. No.: US 2013/0329692 A1
(43) Pub. Date: Dec. 12, 2013

(54) EXTENDING CARRIER ASSIGNMENT BY USE OF DYNAMIC COMPONENT CARRIERS

(71) Applicants: Sophie Vrzic, Nepean (CA); Dongsheng Yu, Nepean (CA); David Steer, Nepean (CA)

(72) Inventors: Sophie Vrzic, Nepean (CA); Dongsheng Yu, Nepean (CA); David Steer, Nepean (CA)

(73) Assignee: BLACKBERRY LIMITED, Waterloo, ON (CA)

(21) Appl. No.: 14/001,374

(22) PCT Filed: Feb. 23, 2011
(86) PCT No.: PCT/IB2011/050757

§ 371 Date: Aug. 23, 2013

(51) Int. Cl. H04W 72/04

(52) U.S. Cl. CPC H04W 72/0406
USPC 370/329

(57) ABSTRACT

A method, system and computer-usable medium are provide for dynamically assigning radio resources (e.g., channels), within a context of a mobile communications network, to heterogeneous nodes such as reconfigurable eNB, Relay Node (RN) and Home eNB (HeNB) and other reconfigurable nodes to improve spectrum utilization. The dynamic assignment of channels for these nodes may be from existing spectrum bands for re-fanning, or from secondary spectrum such as TVWS. Both CA and SON procedures can be extended to enable CR and DSA techniques and improve spectrum utilization. These extensions enable dynamic allocation of fixed, non-legacy component carriers to different nodes within an operator's network, opportunistic use of white space within an operators own licensed bands; and, opportunistic allocation of available channels within TV white space (TVWS) or other dynamically available channels (perhaps in coordination with other operators).

### CROSS REFERENCE TO RELATED APPLICATIONS

U.S. patent application Ser. No. ______, entitled DYNAMICALLY ENABLING COMP BY ASSIGNING DCCS, by inventors Sophie Vrzic, Dongsheng Yu, and David Steer, Attorney Docket No. 39338-1-WO-PCT, filed on even date herewith, describes exemplary methods and systems and is incorporated by reference in its entirety.

U.S. patent application Ser. No. ______, entitled ENABLING COOPERATIVE HARQ TRANSMISSION BY ASSIGNING DCCS, by inventors Sophie Vrzic, Dongsheng Yu, and David Steer, Attorney Docket No. 39338-2-WO-PCT, filed on even date herewith, describes exemplary methods and systems and is incorporated by reference in its entirety.

U.S. patent application Ser. No. ______, entitled EXTENDING A UE HANDOVER PROCEDURE TO TAKE INTO ACCOUNT ASSIGNING DCCS, by inventors Sophie Vrzic, Dongsheng Yu, and David Steer, Attorney Docket No. 39338-3-WO-PCT, filed on even date herewith, describes exemplary methods and systems and is incorporated by reference in its entirety.

U.S. patent application Ser. No. ______, entitled SUPPORTING MULTI-HOP AND MOBILE RECONFIGURABLE NODES, by inventors Sophie Vrzic, Dongsheng Yu, and David Steer, Attorney Docket No. 39338-4-WO-PCT, filed on even date herewith, describes exemplary methods and systems and is incorporated by reference in its entirety.

### BACKGROUND OF THE INVENTION

1. Field of the Invention

The present invention is directed in general to communications systems and methods for operating same, and more particularly to operating configurable radios for dynamic resource allocation in mobile communications systems.

2. Description of the Related Art

In known wireless telecommunications systems, transmission equipment in a base station or access device transmits signals throughout a geographical region known as a cell. As technology has evolved, more advanced equipment has been introduced that can provide services that were not possible previously. This advanced equipment might include, for example, an E-UTRAN (evolved universal terrestrial radio access network) node B (eNB), a base station or other systems and devices. Such advanced or next generation equipment is often referred to as long-term evolution (LTE) equipment, and a packet-based network that uses such equipment is often referred to as an evolved packet system (EPS). An access device is any component, such as a traditional base station or an LTE eNB (Evolved Node B), which can provide user equipment (UE) or mobile equipment (ME) with access to other components in a telecommunications system.

As the number of wireless devices increases and the demand for high data rate services such as video traffic increases, more efficient use of the radio spectrum is likely to be required. Because current wireless systems such as LTE are reaching the theoretical limit in terms of spectral efficiency, future systems will likely need significantly more spectrum to satisfy the increasing demand. Future wireless systems should also be able to handle a multiplicity of users and fragmentation in an available spectrum. Thus, spectrum efficient communications using dynamic resource allocation and optimized multi-band communications is desirable to optimize the use of the available spectrum. For example, spectrum sharing techniques can be used to optimize the spectrum utilization through joint or aggregated use of multiple bands and technologies or through the use of additional channels in a Digital Dividend/White Space UHF or other suitable bands.

Cognitive radio (CR) and dynamic spectrum access (DSA) can provide a more efficient use of an available spectrum in both licensed and unlicensed bands. Although CR and DSA are not specifically defined in the 3GPP LTE standard, some techniques associated with CR are included. For example, in LTE Release 8, self organizing networks (SON) is defined and in LTE-A (Rel. 10), carrier aggregation (CA) is introduced. With self organising networks, when new network radio nodes are added to a network, the nodes are able to self-configure their channel assignments to accommodate local conditions. This self configuration reduces the need for extensive network re-planning and reconfiguration when nodes such as eNBs, relay nodes (RN) or Home eNBs are added to a network. In known systems, such network re-planning is performed manually and can be expensive and time-consuming.

With carrier aggregation in LTE-A (Rel. 10), the system may be configured with multiple up-link/down-link (UL/DL) component carriers (CC) that may be either contiguous or non-contiguous. From the perspective of the eNB and other nodes, CCs are a part of an operator's licensed spectrum and are available for LTE operation for a long period of time (i.e. for the term of the license). An operator may add one or more CCs, at a relatively static pace, e.g. by re-farming underutilized GSM/HSPA/CDMA spectrum for LTE use. Dynamic re-farming of the band can improve the spectrum utilisation for an operator.

With certain known mobile communications systems such as 3GPP, a plurality of possible issues have been identified for taking advantage of CR and DSA techniques. For example, in a heterogeneous wireless communication system, different types of serving nodes, e.g. eNB, Relay Node (RN) and Home eNB (HeNB), may exist within a single cell to serve a variety of users and quality of service (QoS) requirements. As a result, interference among these nodes can become more severe than the single serving node per cell case. Frequency reuse or fractional frequency reuse (FFR) can be implemented for mitigating/avoiding interference. However, further enhancement of inter-cell interference and intra cell interference is likely limited by the range of available spectrum and the flexibility of spectrum usage.

Also for example, re-farming spectrum from other radio access technologies (RATs) for the exclusive use of new systems (e.g. LTE) might not be practical in certain situations. Spectrum band usage for certain legacy RATs (e.g. high speed packet access (HSPA)) may steadily be decreasing, but service to legacy UEs should always be maintained until the RAT is out of service. A full switchover from legacy RAT to LTE might be too drastic and the spectrum used for the legacy RAT might become underutilized for most of the time and/or locations as the usage of legacy equipment decreases. This underutilized spectrum is referred to as white space in a licensed band and can result in poor overall spectrum utilization.

Also for example, in the United States, TV band White Space (TVWS) is now available for secondary use by fixed and portable device communication (the European Union (EU) may also follow). Other types of lightly licensed or unlicensed spectrum are also available. However, channels in the TVWS band are not always available for secondary use. Different channels may be available in different locations, and some locations may have multiple channels available, and some locations may have no channels available. The availability of TVWS channels may also vary with time as some may be used for auxiliary broadcast services. The TVWS channel availability is dynamic. An operator must take this dynamic availability into account when making use of TVWS spectrum or similarly other opportunistic channels.

### BRIEF DESCRIPTION OF THE DRAWINGS

The present invention may be understood, and its numerous objects, features and advantages obtained, when the following detailed description is considered in conjunction with the following drawings, in which:

FIG. 1 depicts an exemplary system in which the present invention may be implemented.

FIG. 2 shows a wireless communications system including an embodiment of a user equipment (UE).

FIG. 3 is a simplified block diagram of an exemplary UE comprising a digital signal processor (DSP).

FIG. 4 is a simplified block diagram of a software environment that may be implemented by the DSP.

FIG. 5 shows a block diagram of an example of a DCC allocation in licensed and unlicensed bands.

FIG. 6 shows a block diagram of an example scenario for DCC allocation to reconfigurable relay nodes.

FIG. 7 shows a timing diagram of a DRX cycle on the PCC.

FIG. 8 shows an example of a DCC contention resolution procedure for contention among nodes within the same cell.

FIG. 9 shows an example of a DCC contention resolution procedure for contention among nodes from different cells.

FIG. 10 shows block diagram of an example of DCC configuration and reconfiguration using a fixed CC.

FIG. 11 shows an example of Spectrum Managers being used to manage shared spectrum between different network operators.

FIG. 12 shows a block diagram of an example of a one available channel time shared by two DL DCCs operating different RATs.

FIG. 13 shows a flow diagram of an example of a CR/DSA operation in 3GPP.

FIG. 14 shows a block diagram of a CoMP transmission.

FIG. 15 shows a block diagram of time sharing of an available channel for use as a DCC.

FIG. 16 shows a flow diagram of an example of cooperative transmission using multiple reconfigurable relay nodes and/or DCCs.

FIG. 17 shows a block diagram of a HARQ combining operation.

FIG. 18 shows a block diagram of en example of a R-UE handover with CoMP transmission when R-UE is associated with a R-eNB.

FIG. 19 shows a timing diagram of a R-UE handover procedure when the R-UE is associated with a R-eNB.

FIG. 20 shows a block diagram of an example of an R-UE handover without CoMP transmission when the R-UE is associated with the R-eNB.

FIGS. 21A and 21B, generally referred to as 21, show a block diagram of an example of an R-UE handover using CoMP when the R-UE is associated with the R-eNB and the R-RN, respectively.

FIG. 22 shows a timing diagram of an R-UE handover procedure with CoMP transmission when the R-UE is associated with the R-RN.

FIG. 23 shows a block diagram of an example of an R-EU handover without CoMP when the R-UE is associated with an R-RN.

FIG. 24 shows a timing diagram of an R-UE handover procedure without COMP transmission when the R-UE is associated with the R-RN.

FIG. 25 shows a block diagram of an example of a mobile reconfigurable relay node.

FIG. 26 shows a signaling diagram of a MR-RN handover.

FIG. 27 shows a block diagram of multi hop reconfigurable relay nodes.

FIG. 28 shows a signaling diagram of an example of multi-hop reconfigurable relay nodes.

FIG. 29 shows a signaling diagram of an example of multi-hop transmission for assisting HARQ.

FIG. 30 shows a signaling diagram of an example of multi-hop reconfigurable relay.

FIG. 31 shows a block diagram of an example of a multi-hop reconfigurable relay assisting mobile R-RN.

FIG. 32 shows a signaling diagram of an example of a multi-hop reconfigurable relay with MR-RN.

### DETAILED DESCRIPTION

A method and system are provided for dynamically assigning radio resources (e.g., channels), within a context of a mobile communications network, to heterogeneous nodes such as reconfigurable eNB, Relay Node (RN) and Home eNB (HeNB) and other reconfigurable nodes to improve spectrum utilization. The dynamic assignment of channels for these nodes may be from existing mobile spectrum bands, or from secondary spectrum such as TVWS. Both CA and SON procedures can be extended to enable CR and DSA techniques and improve spectrum utilization. These extensions enable dynamic allocation of channels as component carriers to different nodes within an operator's network, opportunistic use of white space within an operators own licensed bands; and, opportunistic allocation of available channels within TV white space (TVWS) or other dynamically available channels (perhaps from other operators).

In CA (e.g., as proposed in LTE), a UE, RN and eNB can be assigned multiple component carriers (CC) for both UL and DL communication. In accordance with one aspect of the present invention, CA is extended to facilitate the management of multiple component carriers including CC from different RATs and that may be operated in different modes. In this management, for example, one of the component carriers can be designated as a primary component carrier (PCC). Signalling and control information can be transported over this primary component carrier to assign dynamic component carriers (DCC) for use by UE, RN, eNB and other network nodes. A DCC can be located within the white space of a licensed band of a network operator or in another licensed or unlicensed band. For example, a DCC can be a component carrier that is dynamically allocated to different nodes within the network of an operator or a DCC can be a channel in the TVWS.

The PCC and the DCC can operate in either TDD or FDD mode. The DCC does not have to operate in the same duplex mode as the PCC, and they do not need to use the same radio access technology (RAT).

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the inventor's specific goals, such as compliance with radio access system technology or design-related constraints, which will vary from one implementation to another. WHILE such a development effort might be complex and time-consuming, it would nevertheless be a routine undertaking for those of skill in the art having the benefit of this disclosure. For example, selected aspects are shown in block diagram and flow chart form, rather THAN in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art.

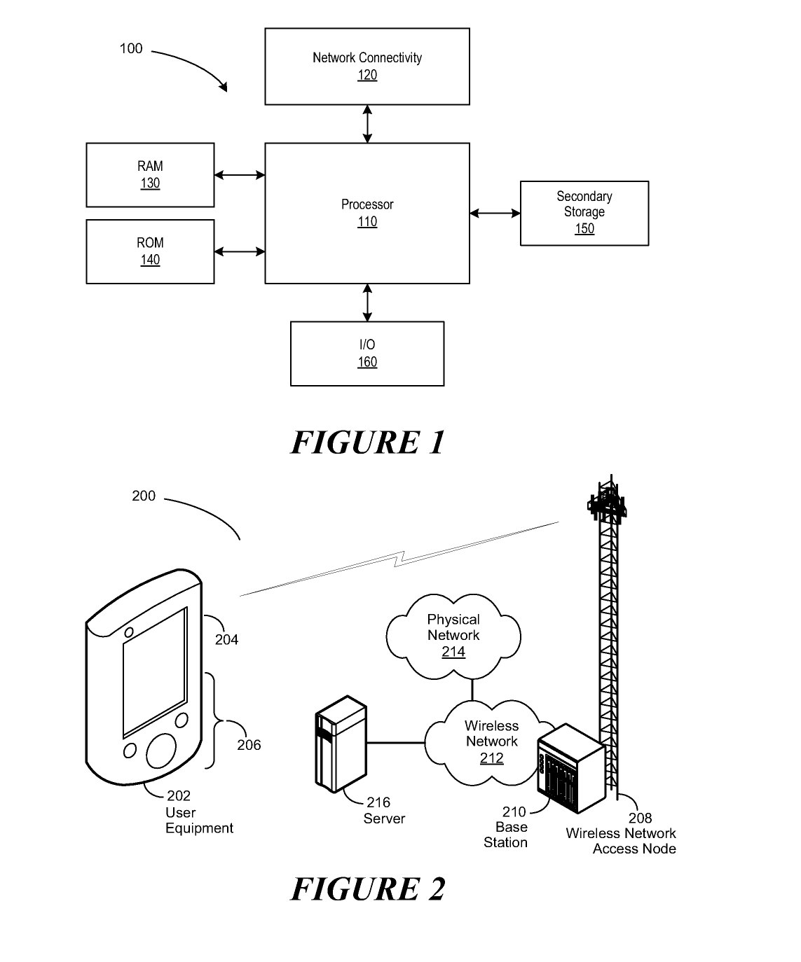

FIG. 1 illustrates an example of a system 100 suitable for implementing one or more embodiments disclosed herein. In various embodiments, the system 100 comprises a processor 110, which may be REFERRED to as a central processor unit (CPU) or digital signal processor (DSP), network connectivity devices 120, random access memory (RAM) 130, read only memory (ROM) 140, secondary storage 150, and input/output (I/O) devices 160. In some embodiments, some of these components may not be present or may be combined in various combinations with one another or with other components not shown. These components may be located in a single physical entity or in more than one physical entity. Any actions described herein as being taken by the processor 110 might be taken by the processor 110 alone or by the processor 110 in conjunction with one or more components shown or not shown in FIG. 1.

The processor 110 executes instructions, codes, computer programs, or scripts that it might access from the network connectivity devices 120, RAM 130, or ROM 140. While only one processor 110 is shown, multiple processors may be present. Thus, while instructions may be discussed as being executed by a processor 110, the instructions may be executed simultaneously, serially, or otherwise by one or multiple processors 110 implemented as one or more CPU chips.

In various embodiments, the network connectivity devices 120 may take, for example, the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, long-term evolution (LTE) devices (including LTE Advanced (LTE-A)), worldwide interoperability for microwave access (WiMAX) devices, and/or other well-known devices for connecting to networks. These network connectivity devices 120 may enable the processor 110 to communicate with the Internet or one or more telecommunications networks or other networks from which the processor 110 might receive information or to which the processor 110 might output information.

The network connectivity devices 120 may also be capable of transmitting or receiving data wirelessly in the form of electromagnetic waves, such as radio frequency signals or microwave frequency signals. INFORMATION transmitted or received by the network connectivity devices 120 may include data that has been processed by the processor 110 or instructions that are to be executed by processor 110. The data may be ordered according to different sequences as may be desirable for either processing or generating the data or transmitting or receiving the data.

In various embodiments, the RAM 130 may be used to store volatile data and instructions that are executed by the processor 110. The ROM 140 shown in FIG. 1 may be used to store instructions and perhaps data that are read during execution of the instructions. Access to both RAM 130 and ROM 140 is typically faster than to secondary storage 150. The secondary storage 150 is typically comprised of one or more disk drives or tape drives or flash memory cards and may be used for non-volatile storage of data or as an over-flow data storage device if RAM 130 is not large enough to hold all working data. Secondary storage 150 may be used to store programs that are loaded into RAM 130 when such programs are selected for execution. The I/O devices 160 may include liquid crystal displays (LCDs), touch screen displays, keyboards, keypads, switches, dials, mice, track balls, voice recognizers, card readers, paper tape readers, printers, video monitors, or other well-known input/output devices.

FIG. 2 shows a wireless communications system including an embodiment of user equipment (UE) 202. Though illustrated as a mobile phone, the UE 202 may take various forms including a wireless handset, a pager, a personal digital assistant (PDA), a portable computer, a tablet computer, or a laptop computer. Many suitable devices combine some or all of these functions. In some embodiments, the UE 202 is not a general purpose computing device like a portable, laptop or tablet COMPUTER, but rather is a special-purpose communications device such as a mobile phone, a wireless handset, a pager, a PDA, or a telecommunications device installed in a vehicle. The UE 202 may likewise be a device, include a device, or be included in a device that has similar capabilities but that is not transportable, such as a desktop computer, a set-top box, or a network node. In these and other embodiments, the UE 202 may support specialized activities such as gaming, inventory control, job control, and/or task management functions, and so on.

In various embodiments, the UE 202 includes a display 204. The UE 202 likewise includes a touch-sensitive surface, a keyboard or other input keys 206 generally used for input by a user. In these and other environments, the keyboard may be a full or reduced alphanumeric keyboard such as QWERTY, Dvorak, AZERTY, and sequential keyboard types, or a traditional numeric keypad with alphabet letters associated with a telephone keypad. The input keys may LIKEWISE include a trackwheel, an exit or escape key, a trackball, and other navigational or functional keys, which may be inwardly depressed to provide further input function. The UE 202 may likewise present options for the user to select, controls for the user to actuate, and cursors or other indicators for the user to direct.

The UE 202 may further accept DATA entry from the user, including telephone numbers to dial or various parameter values for configuring the operation of the UE 202. The UE 202 may further execute one or MORE software or firmware applications in response to user commands. These applications MAY configure the UE 202 to perform various customized functions in response to user interaction. Additionally, the UE 202 may be programmed or configured over-the-air (OTA), for example from a wireless base station 210, a server 216, a wireless network access node 208, or a peer UE 202.

Among the various applications executable by the UE 100 are a web browser, which enables the display 204 to display a web page. The web page may be obtained via wireless communications with a wireless network access node 208, such as a cell tower, a peer UE 202, or any other wireless communication network 212 or system. In various embodiments, the wireless network 212 is coupled to a wired network 214, such as the Internet. Via the wireless network 212 and the wired network 214, the UE 202 has access to information on various servers, such as a server 216. The server 216 may provide content that may be shown on the display 204. Alternately, THE UE 202 may access the wireless network 212 through a peer UE 202 acting as an intermediary, in a relay type or hop type of connection. Skilled practitioners of the art will recognized that many such embodiments are possible and the foregoing is not intended to limit the spirit, scope, or intention of the disclosure.

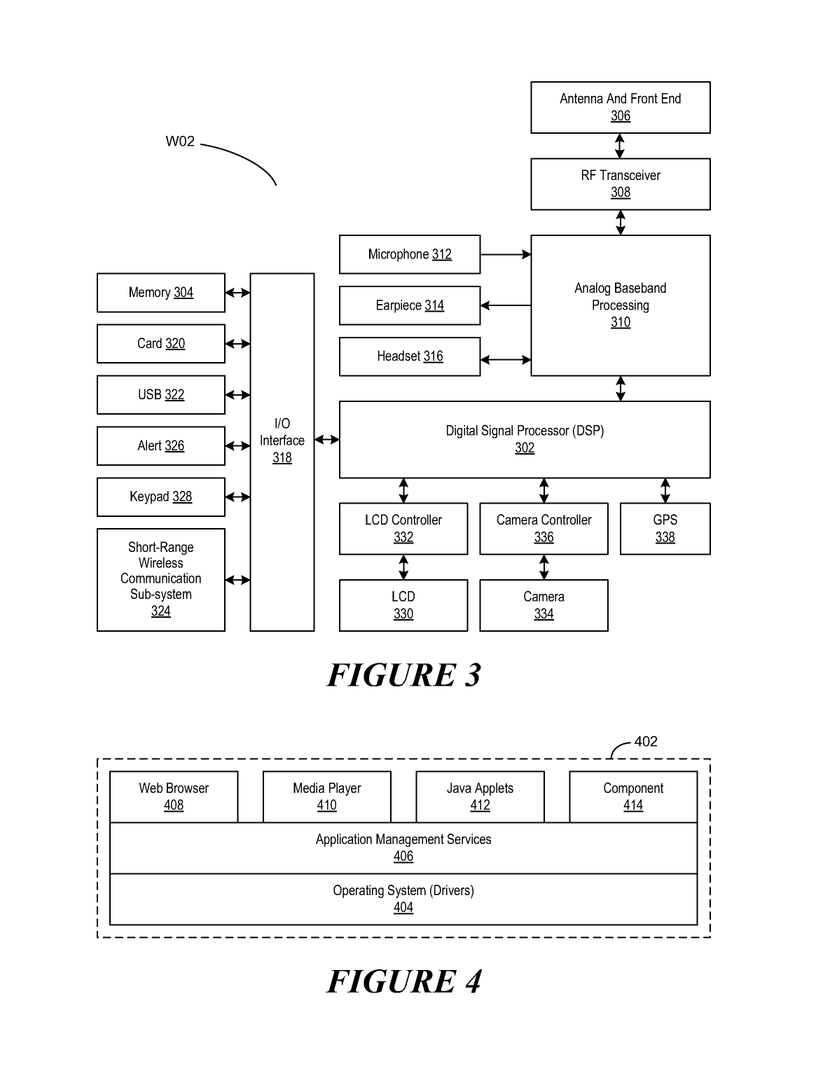

FIG. 3 depicts a block diagram of an exemplary user equipment (UE) 202 in which the present invention may be implemented. While various components of a UE 202 are depicted, various embodiments of the UE 202 may include a subset of the listed components or additional components not listed. As SHOWN in FIG. 3, the UE 202 includes a digital signal processor (DSP) 302 and a memory 304. As shown, the UE 302 may further include an antenna and front end unit 306, a radio frequency (RF) transceiver 308, an analog baseband processing unit 310, a microphone 312, an earpiece speaker 314, a headset port 316, an input/output (I/O) interface 318, a removable memory card 320, a universal serial bus (USB) port 322, a short range wireless communication sub-system 324, an alert 326, a keypad 328, a liquid crystal display (LCD) 330, which may include a touch sensitive surface, an LCD controller 332, a charge-coupled device (CCD) camera 334, a camera controller 336, and a global positioning system (GPS) sensor 338. In various embodiments, the UE 202 may include another kind of display that does not provide a touch sensitive screen. In an embodiment, the DSP 302 may communicate directly with the memory 304 without passing through the input/output interface 318.

In various embodiments, the DSP 302 or some other form of controller or central processing unit (CPU) operates to control the various components of the UE 202 in accordance with embedded software or firmware stored in memory 304 or stored in memory contained within the DSP 302 itself. In addition to the embedded software or firmware, the DSP 302 may execute other applications stored in the memory 304 or made available via information carrier media such as portable data storage media like the removable memory card 320 or via wired or wireless network communications. The application software may comprise a compiled set of machine-readable instructions that configure the DSP 302 to provide the desired functionality, or the application software may be high-level software instructions to be processed by an interpreter or compiler to indirectly configure the DSP 302.

The antenna and front end unit 306 may be provided to convert between wireless signals and electrical signals, enabling the UE 202 to send and receive information from a cellular network or some other AVAILABLE wireless communications network or from a peer UE 202. In an embodiment, the antenna and front end unit 306 may include multiple antennas to support beam forming and/or multiple input multiple output (MIMO) operations. As is known to those skilled in the art, MIMO operations may provide spatial diversity which can be used to overcome difficult channel conditions or to increase channel throughput. Likewise, the antenna and front end unit 306 may include antenna tuning or impedance matching components, RF power amplifiers, or low noise amplifiers.

In various embodiments, the RF transceiver 308 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 310 or the DSP 302 or other central processing unit. In some EMBODIMENTS, the RF Transceiver 308, portions of the Antenna and Front End 306, and the analog base band processing unit 310 may be combined in one or more processing units and/or application specific integrated circuits (ASICs).

The analog baseband processing unit 310 may provide various analog processing of inputs and outputs, for example analog processing of inputs from the microphone 312 and the headset 316 and OUTPUTS to the earpiece 314 and the headset 316. To that end, the analog baseband processing unit 310 may have ports for connecting to the built-in microphone 312 and the earpiece speaker 314 that enable the UE 202 to be used as a cell phone. The analog baseband processing unit 310 may further include a port for connecting to a headset or other hands-free microphone and speaker configuration. The analog baseband processing unit 310 may provide digital-to-analog conversion in one signal direction and analog-to-digital conversion in the opposing signal direction. In various embodiments, at least some of the functionality of the analog baseband processing unit 310 may be provided by digital processing components, for example by the DSP 302 or by other central processing units.

The DSP 302 may perform modulation/demodulation, coding/decoding, interleaving/deinterleaving, spreading/DESPREADING, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 302 may perform modulation, coding, interleaving, and spreading, and for a receiver function the DSP 302 may perform despreading, deinterleaving, decoding, and demodulation. In another embodiment, for example in an orthogonal frequency division multiplex access (OFDMA) technology application, for the transmitter function the DSP 302 may perform modulation, coding, interleaving, inverse fast Fourier transforming, and cyclic prefix appending, and for a receiver function the DSP 302 may perform cyclic prefix removal, fast Fourier transforming, deinterleaving, decoding, and demodulation. In other wireless technology applications, yet other signal processing functions and combinations of signal processing functions may be performed by the DSP 302.

The DSP 302 may communicate with a wireless network via the analog baseband processing unit 310. In some embodiments, the communication may provide Internet connectivity, enabling a user to gain access to content on the Internet and to send and receive e-mail or text messages. The input/output interface 318 interconnects the DSP 302 and various memories and interfaces. The memory 304 and the removable memory card 320 may provide software and data to configure the operation of the DSP 302. Among the interfaces may be the USB interface 322 and the short range wireless communication sub-system 324. The USB interface 322 may be used to charge the UE 202 and may also enable the UE 202 to function as a peripheral device to exchange information with a personal computer or other computer system. The short range wireless communication sub-system 324 may include an infrared port, a Bluetooth interface, an IEEE 802.11 compliant wireless interface, or any other short range wireless communication sub-system, which may enable the UE 202 to communicate wirelessly with other nearby mobile devices and/or wireless base stations.

The input/output interface 318 may further connect the DSP 302 to the alert 326 that, when triggered, causes the UE 202 to provide a notice to the user, for example, by ringing, playing a melody, or vibrating. The alert 326 may serve as a mechanism for alerting the user to any of various events such as an incoming call, a new text message, and an appointment reminder by silently vibrating, or by playing a specific pre-assigned melody for a particular caller.

The keypad 328 couples to the DSP 302 via the I/O interface 318 to provide one mechanism for the user to make selections, enter information, and otherwise provide input to the UE 202. The keyboard 328 may be a full or reduced alphanumeric keyboard such as QWERT3, Dvorak, AZERTY and sequential types, or a traditional numeric keypad with alphabet letters associated with a telephone keypad. The input keys may likewise include a trackwheel, an exit or escape key, a trackball, and other navigational or functional keys, which may be inwardly depressed to provide FURTHER input function. Another input mechanism may be the LCD 330, which may include touch screen capability and also display text and/or graphics to the user. The LCD controller 332 couples the DSP 302 to the LCD 330.

The CCD camera 334, if equipped, enables the UE 202 to take digital pictures. The DSP 302 communicates with the CCD camera 334 via the camera controller 336. In another embodiment, a camera operating according to a technology other than Charge Coupled Device cameras may be employed. The GPS sensor 338 is coupled to the DSP 302 to decode global positioning system signals, thereby enabling THE UE 202 to determine its position. Various other peripherals may also be included to provide additional functions, such as radio and television reception.

FIG. 4 illustrates a software environment 402 that may be implemented by the DSP 302. The DSP 302 executes operating system drivers 404 that provide a platform from which the rest of the software operates. The operating system drivers 404 provide drivers for the UE 202 hardware with standardized INTERFACES that are accessible to application software. The operating system drivers 404 include application management services (AMS) 406 that transfer control between applications running on the UE 202. Also shown in FIG. 4 are a web browser application 408, a media player application 410, and Java applets 412. The web browser application 408 configures the UE 202 to operate as a web browser, allowing a user to enter information into forms and select links to retrieve and view web pages. The media player application 410 configures the UE 202 to retrieve and play audio or audiovisual media. The Java applets 412 configure the UE 202 to provide games, utilities, and other functionality. A component 414 might provide functionality described herein. The UE 202, a base station 210, and other components described herein might include a processing component that is capable of executing instructions related to the actions described above.

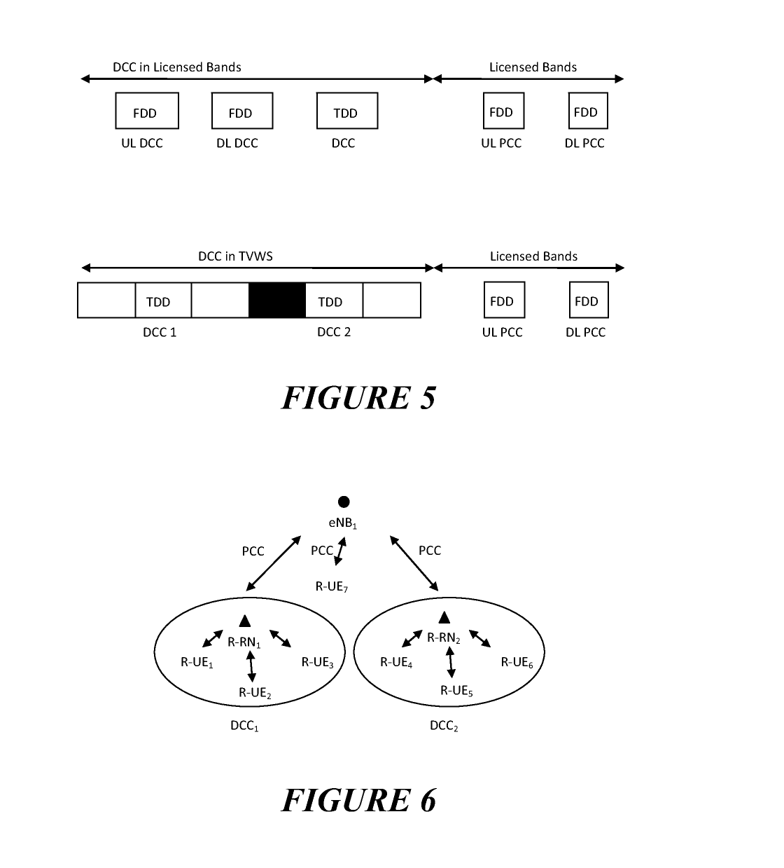

Referring now to FIGS. 5 and 6, a block diagram of an example of a DCC allocation in licensed and unlicensed bands and a block diagram of an example scenario for DCC allocation to reconfigurable relay nodes are shown.

More specifically, dynamic component carriers (e.g., DCC₁ and DCC₂) can be assigned to various nodes within a network by an eNB (e.g., eNB₁). Because a DCC may be dynamically reassigned to another available physical channel, the nodes that are assigned the DCC must be able to tune to the new CHANNEL whenever it is reassigned. The nodes with this tuning capability that are assigned at least one DCC are referred to as reconfigurable nodes. For example, a relay node (RN) that is assigned a DCC is referred to as a reconfigurable relay node and is denoted as an R-RN. Similarly, a reconfigurable UE is denoted as an R-UE and a reconfigurable eNB is denoted as an R-eNB. An RN or UE may be identified as a reconfigurable node on initial access to the network during the capability exchange procedure with a reconfigurable eNB.

When a DCC is configured for use by reconfigurable nodes, a DCC configuration message is sent to the nodes. The DCC configuration message may contain information that is similar to system information block that is broadcast for the PCC. The DCC configuration message may also contain ADDITIONAL information specific to DCCs such as the carrier frequency of the DCC, the radio access technology, the frame structure, which may include the frame duration and multiplexing mode (TDD/FDD), etc.

Because a DCC may only be available for some limited period of time, the DCC may be reassigned. The reassignment messages may be sent to the reconfigurable nodes using the signalling facilities of the PCC. The reconfiguration message can be a broadcast message or a multicast message that is sent to all the reconfigurable nodes that are assigned the DCCs.

A DCC may be time shared by many nodes within a network or among several networks. Typically, in this case, there is no interpolation of reference symbols across multiple sub-frames for channel estimation. THIS limitation applies to all nodes using the DCC including R-UEs, R-RNs and R-eNBs. Alternatively, in certain embodiments, interpolation may be allowed across some sub-frames when the sub-frames are used by the same nodes. In this alternative, some signalling is used to indicate whether or not interpolation is allowed. This signalling can be included in the configuration message for the DCC or in some broadcast/multicast signalling message sent in each sub-frame to indicate whether interpolation can be used between the current sub-frame and the previous sub-frame. The DCC configuration messages are typically sent to the R-UE, R-RN or R-eNB on the PCC.

A DCC may be assigned to an R-RN for communication with cell edge UEs. In this case, the eNB may send the data for the cell edge UEs to the R-RN on a PCC and the R-RN schedules and sends the data to the cell edge UEs on the DCC. The R-RN behaves as an R-UE when communicating with the R-eNB on the PCC and as an R-eNB when communicating with the CELL edge R-UEs on the DCC. Some R-UEs that are close to the R-eNB may only be communicating with the R-eNB (on the PCC). This scenario is illustrated in FIG. 6.

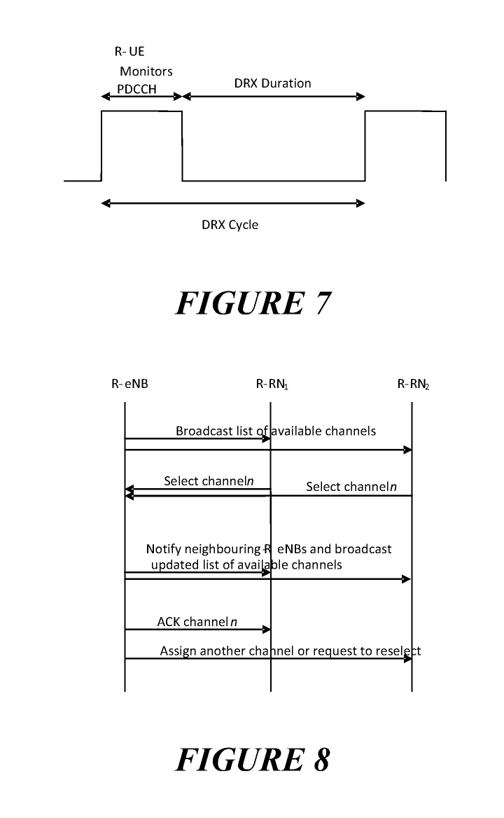

The R-UEs can communicate with the R-eNB on the PCC while communicating with the R-RN on the DCC. The R-UEs can be configured to use discontinuous transmission (DRX) on the PCC for some interval to reduce the frequency of monitoring the PCC. The DRX interval depends on whether or not the R-UE has any traffic on the PCC. If the R-UE does not have any other data service on the PCC, the R-UE may continue to monitor the control channel (e.g., a packet dedicated control channel (PDCCH) in LTE) to determine if there is any DCC reconfiguration message. FIG. 7 illustrates the DRX cycle on the PCC. This PCC and DCC allocation can be used to improve system capacity, coverage and battery life.

The DCC allocation to R-RNs can be either a contention based method or a non-contention based method. The method used may depend on the location of the available channels. If the available channels are within the network operator's licensed allocation, a non-contention based method may be used. However, if the available channels are within TVWS or some portion of the spectrum that is designated as shared spectrum then a contention based method may be more appropriate.

In a contention based method, the R-RN first determines which channels are available for use as a DCC by sensing, reading a database or through information from broadcast signalling from the R-eNB. The R-RN then selects one of the available channels and begins to transmit some broadcast signalling on the selected channel relevant to the RAT to be used on the DCC. The R-RN notifies the R-eNB of the selected channel. If another node also selects the same channel then a contention resolution procedure may begin. The contention resolution procedure may be performed by the R-eNB.

An example of a case where the nodes contending for the same channel belong to the same cell is illustrated in FIG. 8. In this example, the two nodes are reconfigurable relay nodes. Each R-RN sends its requested channel to the R-eNB or to a Spectrum Manager, which may be located at the R-eNB. Once the R-eNB receives both requests for the same channel, the R-eNB determines which R-RN will be allocated the channel and which R-RN should be instructed to reselect another available channel. The R-eNB then notifies the neighbouring R-eNBs of the allocation and then notifies the contending nodes.

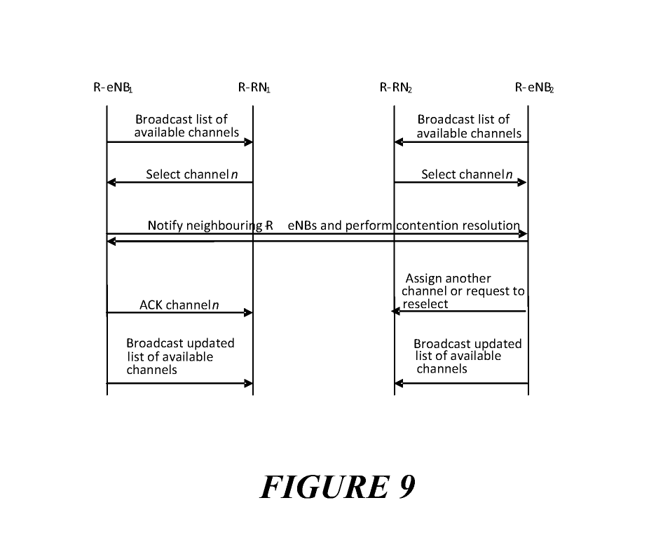

If the nodes contending for the same available channel belong to different cells within the same network then the contention resolution procedure contains an additional step of resolving the contention BETWEEN cells. This additional step is illustrated in FIG. 9.

In a non-contention based method, the R-eNB or a Spectrum Manager, which may be located at an R-eNB may request the R-RN to feedback interference measurements on a set of available channels. From these measurement reports, the R-eNB can assign a channel (e.g., the best channel (i.e., the channel with the least potential interference to existing usage and which will accommodate the traffic with the least channel occupancy time)) to be used as a DCC.

Once DCCs are allocated to the R-RNs, the R-UEs can be associated with an R-RN based on channel measurements of the DCCs requested by the R-eNB. The R-eNB sends a request to the R-UE to MEASURE and report the signal strength on a set of DCCs that were allocated to different nodes within the cell by the R-eNB. The measurements may be based on the reference signals or may be based on neighbour cell measurements. From the reported channel measurements, the R-eNB may allocate one or more DCCs to the R-UE.

The R-UE association can also be initiated by the R-UE after initial access to the network. If the DCC configuration list is broadcast to the mobile devices by the R-eNB then the R-UE can make measurements on the DCCs used within the cell. These measurements can be similar to neighbour cell measurements used for cell selection. An event trigger may be defined for THE R-UE to initiate a request for a DCC. For example, when the R-UE moves closer to an R-RN, the channel condition becomes better on the DCC used by the R-RN compared with the channel condition on the PCC used by the R-eNB. This condition may trigger an event to request the DCC used by the R-RN. The PCC assigned to an R-RN may be different from the PCC assigned to the R-UEs that are associated with the R-RN. Different R-UEs can have a different PCC even if they are associated with the same R-eNB.

A DCC can be assigned to an R-UE for both UL and DL communication with an R-RN, an R-eNB or a DCC being assigned for only one of the links. For example, a DCC may be used for DL communication to an R-UE and a PCC may be used for UL communication. This example may be applicable to the case where the DL channel is provided by an operator that only has a DL channel, such as a TV service operator. Since the TV operator does not have an UL channel on which to receive requests, the PCC can be used for this purpose. In this case, the R-UE can send a request to the R-eNB on the UL PCC (e.g. for a video download). After receiving the request from the R-UE, the R-eNB can send the request to the TV operator. The R-eNB then allocates a TV channel as a DCC to the R-UE. The TV operator then transmits the data to the R-UE on the allocated DCC (e.g., TV channel or a multiplex configuration within a digital TV transmission).

If the nodes that are transmitting on the DL PCC and the DL DCC are synchronized, then the R-UEs can synchronize on the PCC without having to perform additional synchronization on the DL DCC. However, if the nodes are not synchronized, then the R-UE may need to perform DL synchronization on the DCC in addition to the PCC. In this case, a DL synchronization channel is included on the DL DCC.

Similarly, the R-UE may need to perform UL synchronization if the UL DCC is used by a different node than the UL PCC. The UL DCC synchronization may be included in the DCC allocation procedure for the R-UE. To perform UL synchronization, the R-UE may use either a contention based random access method or a non-contention based random access (RA) method on the DCC. In THE non-contention based method, the RA preamble can be a dedicated preamble that is assigned to the R-UE by the R-eNB during the DCC allocation.

Because DCCs may be dynamically assigned in a region of the band shared with other users, the nodes that are assigned such a dynamic DCC may be required to sense the channel before transmitting. If ANOTHER user is detected, the node may be required to stop or defer transmitting on the DCC to facilitate sharing of the DCC. The type of sensing performed and the decision on whether or not to stop or defer transmission may depend on the location of the DCC, the form of the RAT being used and the conditions of shared use. Sensing information may also be used for interference mitigation among the multiple users of the DCC by enabling selection of DCC parameters that minimize interactions.

In the case of the white space scenarios (e.g. TVWS or White Space within an operator's bands), synchronized sensing intervals may be used to monitor system activity by other users (e.g. primary or other operating DEVICES). Some of the sensing may be performed by sensing nodes, which can be distributed across the network coverage area or located at the periphery of the network coverage area. The sensing nodes provide the sensing information to the operating devices and to the network resource allocation process using the communications and signalling capabilities of the network interconnecting the nodes.

The R-eNB may at intervals communicate on the PCC information about the available opportunistic channels. This communications message may indicate the primary usage of the spectrum, for example by including a radio environment map. The message may also include other maps, for example, to indicate the secondary usage. The R-eNB may also communicate a list of potential DCCs. The primary and secondary usage indicator messages may be used by other devices to determine which channels are available for use as DCCs. This information may be used to resolve the DCC assignment in cases where there is contention for obtaining a DCC. An R-RN can contend for an available channel and if successful the R-RN can notify the R-eNB or the Spectrum Manager of the selected DCC. The R-eNB can then update the secondary usage map. Alternatively, the R-RN can select a specific channel for use as a DCC using a non-contention based method. The R-eNB or the Spectrum Manager can update the secondary usage map accordingly.

The operator of a Cognitive Radio (CR) enabled radio access network may also determine the availability of other dynamically available DCCs within its network coverage area through a cognitive pilot channel (CPC) and/or through a geo-location database. This database may be provided and administrated by other parties or may be a part of the operator's network facilities. ONCE the operators/RATs are identified, the network operator can negotiate, through the Spectrum Manager, the use of the available spectrum for assigning DCCs. The DCCs can be at different frequencies (than the CPC or the PCC) or they can be time shared among nodes. The DCC can then be assigned to the nodes within the network and can be allocated to individual nodes on an opportunistic basis. Each operator may have its own Spectrum Manager for allocating DCCs within the bands licensed to the operator. A joint Spectrum Manager may be used for shared spectrum.

The same methods used to determine channel availability outside an operator's own spectrum can be used to determine channel availability within the operator's licensed bands. In this scenario, a DCC can be created from a fixed CC. For example, a DCC can be configured by allocating periodic sub-frames on a given CC. To support this dynamic allocation, the DCC CONFIGURATION includes an associated DTX/DRX cycle.

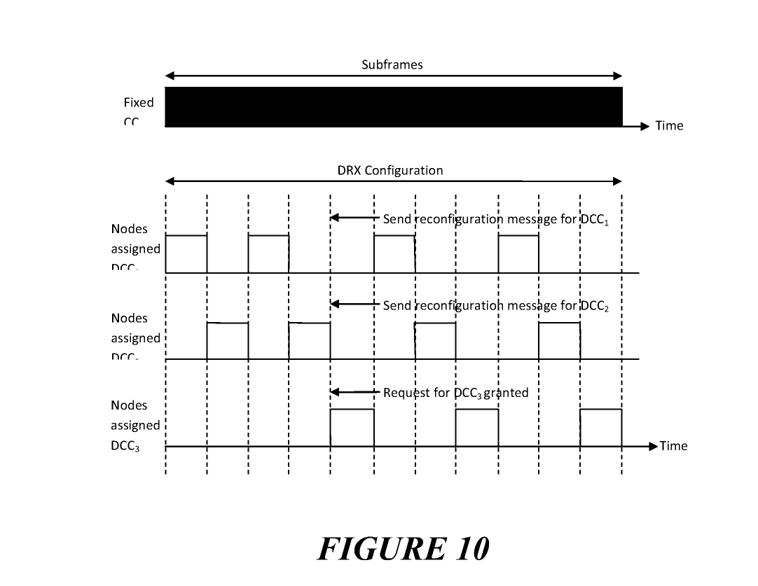

A Spectrum Manager can keep track of which nodes are granted a DCC using a geo-location database. It may also MAKE use of sensing information to determine the best DCC to allocate to the requesting node. The Spectrum Manager may also reconfigure the allocation to accommodate new requests. An example of how a fixed CC is used to create DCCs is illustrated in FIG. 10.

In this example, one fixed CC is allocated to a number of nodes. Initially, two nodes are each allocated a respective DCC (DCC₁ and DCC₂) which uses the same fixed CC. When a request for a third DCC is received, a DCC reconfiguration message is sent to the first two nodes that are using DCC₁ and DCC₂ while a DCC configuration message is sent to the requesting node. The configuration and reconfiguration messages also include the corresponding DTX/DRX cycle to be used by the nodes and all R-UEs communicating with the nodes. In this example, a single fixed CC can be assigned to multiple nodes and used opportunistically as needed. For the nodes that are idle (no R-UEs to serve), the DCC can be deactivated. The DCC can easily be reactivated based on demand.

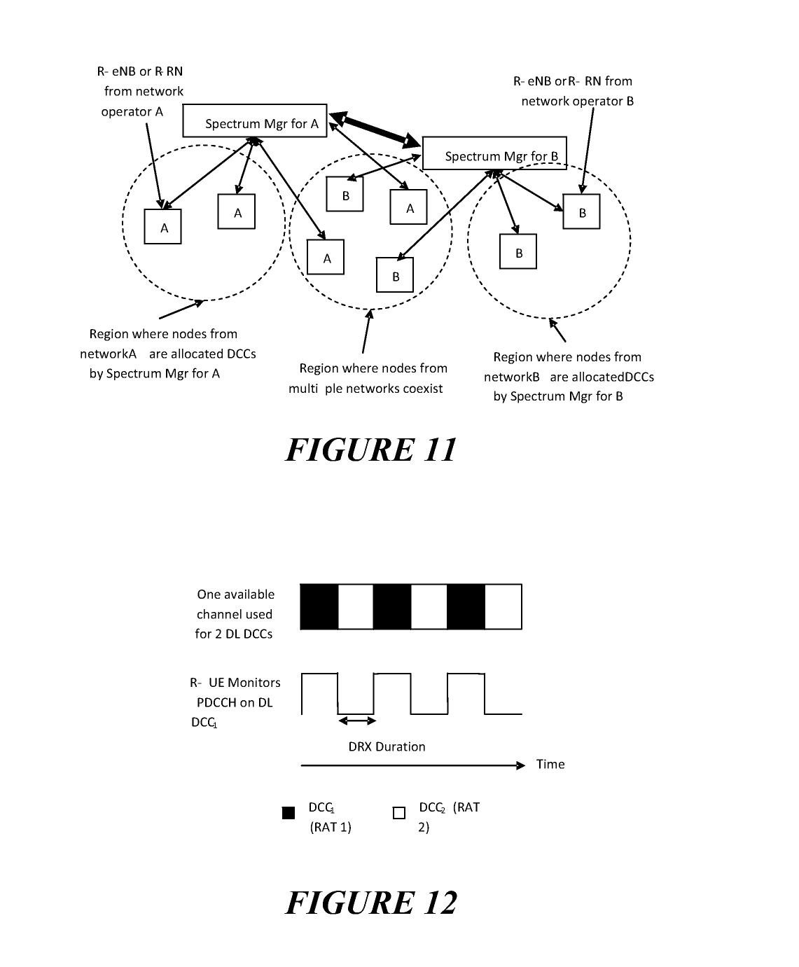

A Spectrum Manager can be used to manage the DCC configuration and reconfiguration messages. The Spectrum Manager can be internal to the network operator in the case where the DCCs are allocated within the network operator's licensed bands or it can be an entity that communicates with other Spectrum Managers from other network operators to negotiate the use of shared spectrum. FIG. 11 shows an example of where Spectrum Managers are used to manage shared spectrum between different network operators.

Each Spectrum Manager may maintain a geo-location database to indicate what channels have been assigned to the different nodes for use as DCCs. A Spectrum Manager may have multiple geo-location DATABASES to keep track of the allocated channels for different parts of the spectrum. For example, one geo-location database may be for the DCCs that have been allocated within the network operator's licensed band. Another geo-location database may be used for shared spectrum (e.g. TVWS).

The radio access technology type used on the DCC can be the same as the PCC or it can be different. A DCC can be assigned for a specific traffic type and the technology type can be optimized for the traffic type. For example, a carrier sense multiple access (CSMA) based system may be preferred for a browsing application, LTE-A may be preferred for video traffic and GSM may be preferred for voice traffic.

To support this opportunistic use of the spectrum, the R-eNB determines the R-UE capabilities, such as the different RATs that are supported, during the R-UE capability exchange on initial entry. Once an R-UE is allocateD a DCC, the R-eNB may configure the DTX/DRX cycle to correspond to the DCC's usage of the allocated channel. This may be appropriate when a frame based RAT is used on the DCC. FIG. 12 shows an example of one available channel being shared by two DL DCCs operating at different RATs.

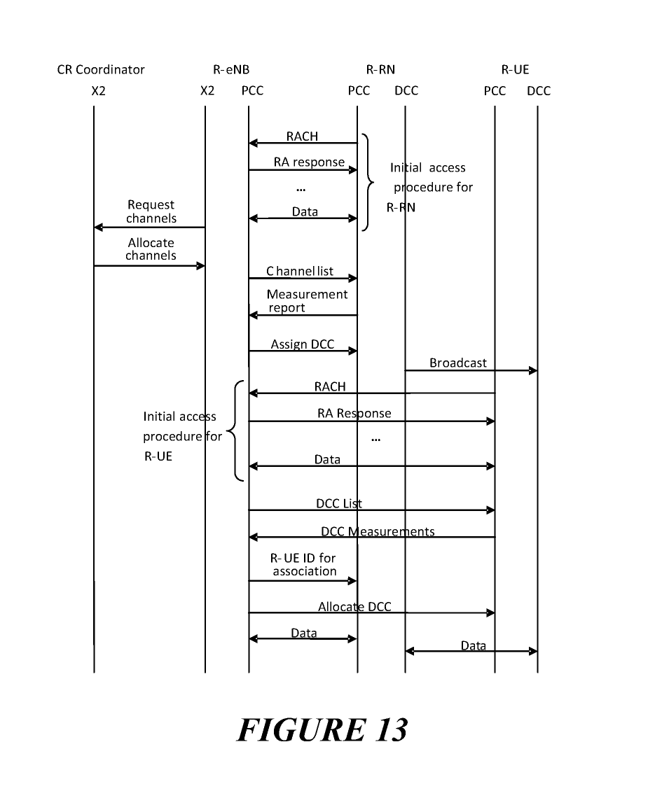

Referring to FIG. 13, a flow diagram of an example of a CR/DSA operation in 3GPP is shown. The configuration for the use of CR/DSA in 3GPP includes a plurality of operations. This configuration includes operations for initial network entry, operations for the Spectrum Manager, operations for the R-ENB, operations for the R-RN, and operations for the R-UE. More specifically, when performing the initial network entry operation, the R-RNs and R-UEs attach to an R-eNB on a PCC. Next, the R-eNB determines the node type (R-RN or R-UE) and whether or not the node is reconfigurable. The R-eNB also determines the capability of the node (e.g. radio access technology). Next, R-eNB assigns an identifier (ID) to the reconfigurable node (R-RN ID). This ID may be used to scramble the data transmitted by the R-eNB on the DL PCC to identify the node. The R-RN ID is also used by the R-RN to scramble the data the R-RN transmits to R-UEs on the assigned DL DCC. Similarly, the reconfigurable nodes scramble the UL data by the assigned ID when transmitting on the PCC or the DCC. The ID used on the DCC can be the same as that used on the PCC or it can be different. The R-eNB can also use the R-RN ID to scramble multicast messages that are intended for the R-RN and all R-UEs that are associated with it. For example, the multicast message can be a DCC re-assignment message.

When configuring the DCC and PCC, the Spectrum Manager monitors, at intervals, the CPC/database, and/or collects sensing information from various sources, to determine the presence of other operators/RATS within the network coverage area. The Spectrum Manager also determines if otheR operators are present, and if so, negotiates the use of TVWS (and/or other dynamically available bands or channels). The Spectrum Manager also selects a set of DCC candidates and assigns the set to nodes within the network. The Spectrum Manager also informs the R-eNBs (and/or other nodes) within the network of their DCC assignment.

When configuring the DCC and PCC, the R-eNB sends a request to the R-RNs to sense/measure the signal strength (e.g. signals and interference) on DCC candidates. The R-eNB also assigns one or more DCCs to each R-RN based on the measured signal strength. The R-eNB also selects one or more DCCs for use by the R-eNB itself. The R-eNB also sends a request to the R-UEs to measure and report the R-RN/R-eNB signal strength on the DCCs that were assigned to the R-RNs/R-eNB. The R-eNB also assigns the R-UEs to an R-RN/R-eNB based on the DCC signal strength report. The R-eNB also sends to each R-RN a list of R-UEs to serve on the DCC.

When configuring the DCC and PCC, the R-RN receives a request to sense a list of potential DCCs and report the measured signal strength. The R-RN also receives a DCC allocation message from the R-eNB. The R-RN also broadcasts a reference signal on the assigned DCC for the R-UEs to measure. The R-RN also receives from the R-eNB a list of R-UEs to serve on the DCC. The R-RN also receives R-UE data from R-eNB on the PCC and sends the data to R-UE on the DCC.

When configuring the DCC and PCC, the R-UE receives from the R-eNB, a DCC configuration message containing the configuration information of all DCCs. This DCC configuration message can be an implicit request to measure the DCCs. Alternatively, a separate message can be sent to instruct the R-UE to measure the DCCs or a set of DCCs. The R-UE also measures and reports the R-RN/R-eNB signal strength of the DCCs requested by the R-eNB. The R-UE also receives a DCC allocation message from the R-eNB. The R-UE also monitors the PCC for a DCC reassignment message from the R-eNB. The R-UE also communicates on the DCC with the reconfigurable node that is assigned the DCC.

The R-UEs that ARE assigned a DCC may also use the PCC for other traffic. Otherwise, if no other traffic is transmitted or received on the PCC then the R-UE can be configured with a discontinuous transmission/reception (DTX/DRX) interval to reduce the frequency of monitoring the DL PCC and in transmitting any feedback on the UL PCC.

Alternatively, the R-UE can be in radio resource control idle (RRC_IDLE) mode with respect to the PCC even if it is in radio resource control connected (RRC_CONNECTED) mode with respect to the DCC. This may be useful when the R-UE is associated with an MR-RN.

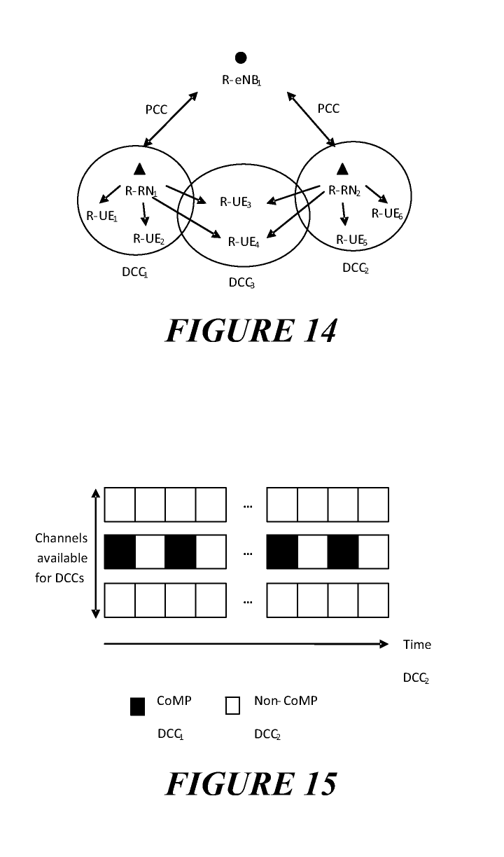

Referring to FIG. 14, a block diagram of a coordinated multi-point (CoMP) transmission is shown. Cooperative multi-point TRANSMISSION may be used to improve cell edge coverage either by using coordinated scheduling or joint transmission. The CoMP transmission has been proposed for LTE-A Rel. 10. However, there are a number of issues in enabling CoMP transmission. Some of the issues include added complexity in coordinating the transmissions when the CoMP transmission is between eNBs; and, a need to define a CoMP region within a subframe to allow joint transmission of both data and reference symbols (the UEs cannot interpolate using the reference symbols from the different regions (e.g., CoMP region/non-CoMP region)). CoMP transmissions are discussed in PCT Patent Application No. PCT/US2010/045527, filed Aug. 13, 2010, entitled Frame Structure and Control Signaling for Downlink Coordinated Multi-Point (CoMP) Transmission, which is hereby incorporated by reference in its entirety.

Because CoMP transmission is only used for a selected group of UEs that may not always have data, it is desirable to dynamically enable CoMP opportunistically (i.e., when opportunities for using CoMP arise). In this way, resources are not wasted by setting up a static CoMP region that may not be used for long periods of time. There are a plurality of use cases of CoMP.

For example, one use case of CoMP comprises cooperative joint transmission using DCCs. In this use case, COMP transmission may be enabled using multiple R-RNs. Multiple R-RNs may either send the same data to a UE or different data. The R-eNB may perform the scheduling and send the scheduling information to the R-RNs that are participating in the CoMP transmission. This process reduces the complexity of the coordination normally required for CoMP transmission. CoMP can also be enabled among multiple R-eNBs/R-RNs with coordination.

In certain embodiments, a separate DCC can be allocated to each of the nodes participating in the CoMP transmission. THE DCC is used opportunistically by the nodes when there is data to send to R-UEs that can benefit from the CoMP transmission.

When performing a CoMP transmission, the R-eNB requests the R-UEs to report the Channel Quality Indicator (CQI) for multiple configured DCCs of candidate nodes (e.g. R-RNs can be assigned DCCs which can be measured). If the best channel quality is similar for multiple nodes then the R-UE is a candidate for CoMP transmission and a DL CoMP transmission set is formed for the R-UE, which includes the nodes that can participate in the DL CoMP transmission to the R-UE. Based on the number of R-UEs that can benefit from CoMP transmission with the same CoMP transmission set, the R-eNB can configure a DCC for the CoMP transmission. The DCC is allocated to the members of the CoMP transmission set and to the candidate R-UEs corresponding to the CoMP transmission set. The R-eNB sends the data for the CoMP R-UEs to the members of the CoMP transmission set on the PCC. The members of the CoMP transmission set (R-RNs) send the data to the R-UEs on the allocated DCC.

The DCCs that are assigned to R-RNs, R-UEs and R-eNBs do not have to be released to share an available channel. A DRX and DTX interval can be defined to allow time sharing of an available channel. Multiple DCC can be configured on the same available channel by including the subframe number and/or the transmission interval. For example, a CoMP DCC can be configured for a specific CoMP transmission set, which can be on a channel shared with non-CoMP transmission. The DCC configuration can include the frequency of the CoMP subframes on the assigned channel. If there is no CoMP data to send then the non-CoMP transmission can be sent on the CoMP subframes.

FIG. 15 illustrates how an available channel can be time shared between a CoMP DCC and a non-CoMP DCC.

Another use case comprises cooperative HARQ with chase combining using multiple R-RNs/DCCs. In this use case, the R-eNB can send the data for an R-UE to a number of R-RNs. The R-UEs THAT are receiving transmissions from multiple R-RNs are allocated the DCCs used by each of the R-RNs. Each R-RN that correctly receives the data from the R-eNB on the PCC transmits the R-UE data on its allocated DCC. The R-UE monitors each of the allocated DCCs used by the R-RNs. If at least one of the transmissions is correctly received, the R-UE sends an acknowledgement (ACK) on each of the UL DCCs to notify all the R-RNs of the successful reception. Because each R-RN sends the same data to the R-UE, the R-UE can use chase combining on the received packets on each of the different DCCs.

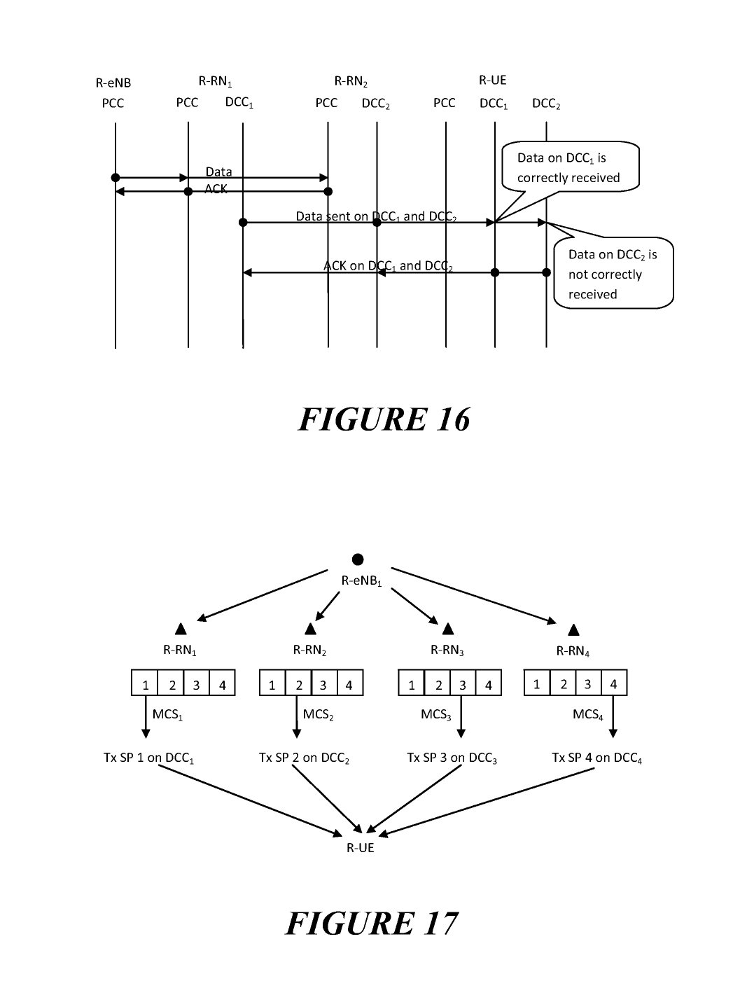

One advantage of this approach is that the R-UE does not have to undergo a handover to another R-RN when the R-UE is moving within the coverage area of the R-RNs. This scenario is illustrated in the signalling diagram in FIG. 16.

Another use case comprises cooperative HARQ with IR combining using multiple R-RNs/DDCs. In this use case, the MULTIPLE transmissions use a hybrid automatic repeat request (HARQ) process with incremental redundancy (IR). In the case of HARQ with IR, each R-RN can send a different HARQ sub-packet. The R-UE combines the received packets and sends an ACK or a NACK on each of the DCCs. This reduces the delay associated with relay when retransmissions are required.

To support HARQ combining across multiple R-RNs and DCCs, each R-RN forms the same set of HARQ sub-packets FOR transmission. The R-eNB configures each R-RN with a sequence of HARQ sub-packets to use for transmission to the R-UE. The R-UE is configured by the R-eNB to receive this type of cooperative transmission after the DCCs are allocated to the R-UE. The configuration message may include the DCCs used for the cooperative transmission and the HARQ sequence of packets that are transmitted on the DCCs.

Once the R-UE is configured, an indicator bit may be included in R-UE's PDCCH assignment message to indicate whether or not this type of cooperative transmission is used. This indicator bit is included in each PDCCH message on each of the DCC used in the cooperative transmission. The R-UE may use this information to determine which sub-packets to combine.

Each R-RN schedules and transmits a sub-packet using a modulation and coding scheme (MCS) appropriate for the DCC that is used. After the R-UE combines the HARQ sub-packets, the R-UE sends an ACK or NACK on each of the UL DCC used for the DL transmission. This process is illustrated in FIG. 17.

If the R-UE sends a NACK then each R-RN sends the next sub-packet in its assigned sequence of sub-packets. This process can also be used with any number of nodes and DCCs including a single R-RN with multiple DCCs.

In another embodiment, the R-eNB can send the first sub-packet to the R-UE on the PCC and only the retransmissions are sent on the DCCs. The R-RNs that are configured for the retransmissions monitor the DL PCC for the R-UE's packet. If the R-UE sends a NACK on the UL PCC (or the UL DCCs) and the R-RN correctly receives the first sub-packet then the R-RN retransmits on the DCC. Each R-RN that is configured to assist the retransmissions transmits on its allocated DCC.

When a R-UE handover and DCC allocation occurs, as the R-UE moves across the network coverage area, the ALLOCATED DCC may no longer be available. In this case, the handover command from the source R-eNB to the R-UE may also include a handover of the allocated DCC. A DCC handover can occur when the R-UE is associated with the R-eNB or an R-RN.

In the case where the R-UE is associated with the R-eNB, the R-UE communicates with the R-eNB on both the PCC and the DCC. If the DCC that is assigned by the source R-eNB is not available or not used by the target R-eNB then the DCC should be released or reassigned. Because the handover interruption time may be reduced with the allocation of a DCC prior to handover, the handover procedure may be extended to include a DCC allocation if a DCC is not assigned.

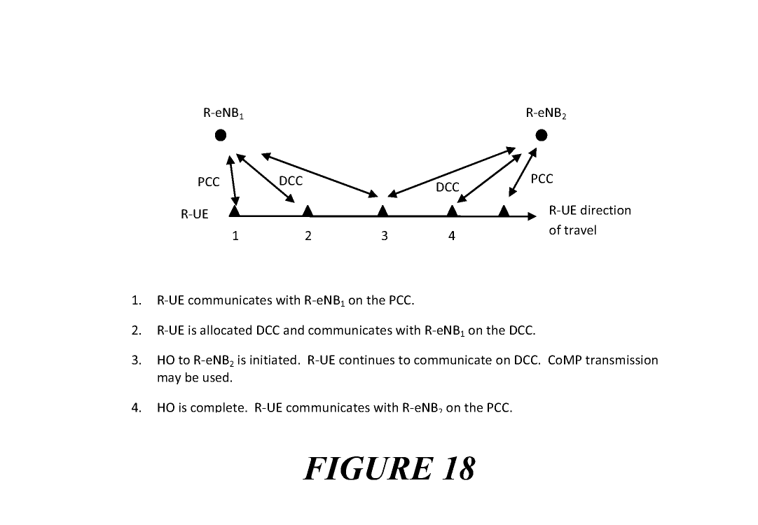

The R-UE handover for this case can be performed with or without CoMP transmission. The case with CoMP transmission is illustrated in FIG. 18. In this example, the DCC can be time shared by both R-eNBs with some sub-frames used for CoMP transmission. Alternatively, the DCC can be a DCC that is configured for CoMP transmission between the two R-eNBs.

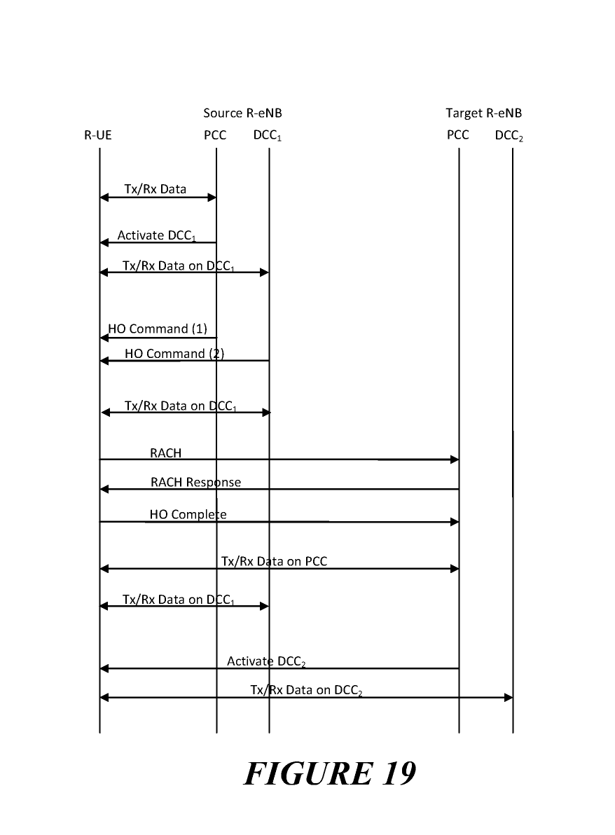

When performing a R-UE handover (HO) operation, when the R-UE is associated with the R-eNB, if the R-UE is allocated a PCC and a DCC then the same HO command is sent on both the PCC and the DCC. This reduces the probability of handover failure. Alternatively, the HO command is sent on only one of the carriers or the HO command is sent on both PCC and DCC with different information on the different carriers. For example, in cases where the PCC is more reliable than the DCC, critical HO information is included on the PCC. Other information that can facilitate, but is not essential to the basic HO procedure, is sent on the DCC. If the DCC information is lost, the HO procedure continues, although perhaps with some additional delay due to the loss of facilitating information. Once the HO command is sent to the R-UE by the source R-eNB, data transmission/reception continues on the DCC while the R-UE synchronizes with the target R-eNB on the PCC. When the HO of the PCC is complete, the target R-eNB sends a command to the R-UE to release the DCC used by the source R-eNB or it sends a command to allocate a new DCC that is used by the target R-eNB itself. FIG. 19 shows a signalling diagram of a R-UE handover procedure with the R-UE is associated with the R-eNB.

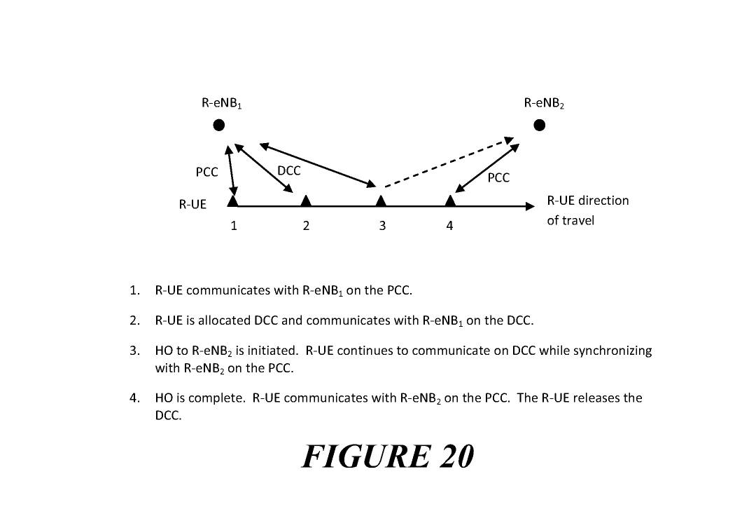

Referring to FIG. 20, an example of a R-UE handover without CoMP transmission when the R-UE is associated with the R-eNB is shown. In this case, the R-UE continues to communicate with the source R-eNB on the DCC while attempting to synchronize with the target R-eNB on the PCC. More specifically, while the R-UE communicates with the R-eNB, the R-UE is allocated the DCC and communicates with the R-eNB (e.g., R-eNB₁) on the DCC. The handover procedure to handover to R-eNB2 is then imitated. The R-UE continues to communicate on the DCC while synchronizing with the new R-eNB (e.g., R-eNB₂) on the PCC. Once the HO procedure on the PCC is complete, the R-UE communicates with the new R-eNB (e.g., R-eNB₂) on the PCC and releases the DCC used by the source R-eNB. This alternative is one of the ways to enable a “make-before-break” handover, by setting up the PCC to the target R-eNB (while maintaining the DCC with the source R-eNB) and then establishing the new DCC with the target R-eNB. This sequence enables data to be delivered uninterrupted to or from the R-UE throughout the transition using either the PCC with the target R-eNB or the DCC from the source R-eNB. This configuration has the advantage that it simplifies the network reconnection for the packets that may be in transit to the source R-eNB and arrive after the set-up of the link to the target R-eNB. Keeping the DCC with the source R-eNB for an interval after the new link to the target R-eNB is established ensures that these packets are delivered in a timely fashion and without the need for them becoming lost or needing to be redirected over the network from the source R-eNB to the target R-eNB.

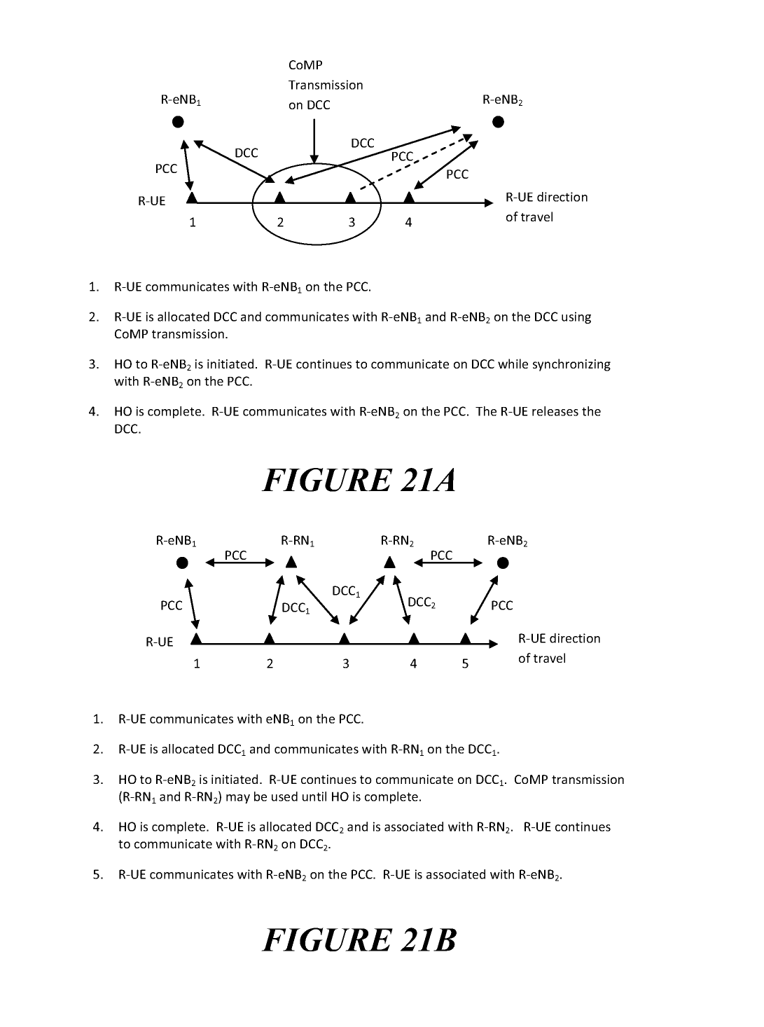

Referring to FIG. 21A, an example of a R-UE handover using CoMP transmission when the R-UE is associated with an R-eNB is shown. In the case where the R-UE is associated with an R-eNB, the R-UE communicates with the R-eNB (e.g., R-eNB₁) on the PCC. As the R-UE moves FROM the souRce cell to the target cell, the R-UE hands over the PCC from the source R-eNB (e.g., R-eNB₁) to the target R-eNB (e.g., R-eNB₂) while communicating with the source and target nodes on the DCC using CoMP transmission. More specifically, the R-UE initially communicates with the source eNB (e.g., R-eNB₁) on the PCC used by R-eNB₁. The R-UE is allocated a DCC and communicates with source R-eNB and the target R-eNB (e.g., R-eNB₁ and R-eNB₂) using CoMP transmission on the DCC. The handover to the R-eNB of the target cell (e.g., R-eNB₂) is initiated on the PCC and/or the DCC, the R-UE continues to communicate on DCC₁ and CoMP transmission (with R-eNB₁ and R-eNB₂) may be used until the handover is completed. When the handover is complete, the R-UE is synchronized with the target R-eNB on the PCC used by R-eNB₂ and is associated with the target R-eNB. The R-UE may be de-allocated the DCC used for CoMP transmission (e.g. DCC₁) and allocated a new DCC used by the target node (e.g. DCC₂)

Referring to FIG. 21B, an example of a R-UE handover using CoMP transmission when the R-UE is associated with an R-RN is shown. In the case where the R-UE is associated with an R-RN (e.g., R-RN₁), the R-UE communicates with the R-eNB (e.g., R-eNB₁) on the PCC and an R-RN (e.g., R-RN₁) on a DCC (e.g., DDC₁). As the R-UE moves from the source cell to the target cell, the R-UE hands over from the R-RN on the assigned DCC to either the target R-eNB (e.g., R-eNB₂) or a target R-RN (e.g., R-RN₂). The handover procedure can be performed with and without CoMP transmission. More specifically, the R-UE initially communicates with the source R-eNB (e.g., R-eNB₁) on the PCC. The R-UE is allocated DCC₁ and communicates with the source R-RN (e.g., R-RN₁) on the DCC (e.g. DCC₁). The handover of the PCC to the R-eNB of the target cell (e.g., R-eNB₂) is initiated, the R-UE continues to communicate on DCC₁ and CoMP transmission (with R-RN₁ and R-R₂) may be used until the handover is completed. When the handover of the PCC is complete and the R-UE moves closer to the target R-RN, the R-UE is allocated DCC₂ and is associated with the target R-RN (e.g. R-RN₂). The R-UE may release DCC₁ and continue to communicate with the target cell (e.g., R-RN₂) on DCC₂. As the R-UE moves closer to the target R-eNB, the R-UE communicates with the target eNB (e.g., R-eNB₂) on the PCC used by R-eNB₂. The R-UE is then associated with the target R-eNB (e.g., R-eNB₂) and may release DCC₂.

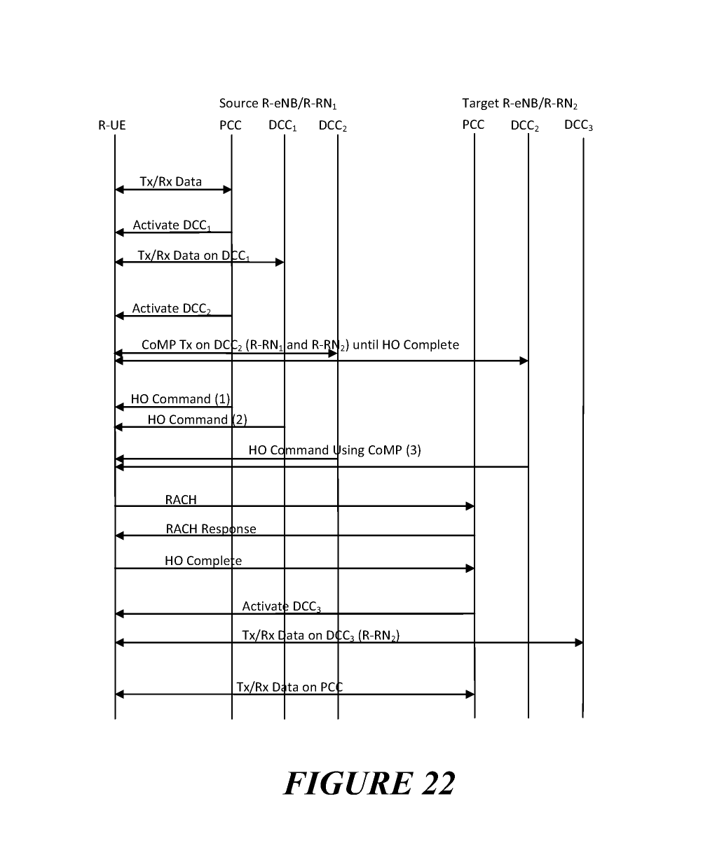

Referring to FIG. 22, a signalling diagram of an example of a R-UE handover case with CoMP transmission when the R-UE is associated with the R-RN is shown. More specifically, for the case with CoMP transmission in preparation for HO the source R-eNB allocates a new DCC to be used by both the source and target R-eNBs for CoMP transmission to the R-UE. The R-UE then receives a HO command from the source R-eNB on the PCC and/or a HO command on the DCC from the source R-RN. Alternatively, the HO command may be sent using CoMP transmission on the DCC allocated for CoMP. After receiving the HO command, the R-UE synchronizes with the target R-eNB on the PCC. The R-UE may still be transmitting/receiving data on the DCC while performing the synchronization. Once synchronization is complete, the R-UE sends a HO Complete message to the target R-eNB. The R-UE may continue to transmit/receive on the DCC allocated for CoMP. The R-UE is allocated a DCC used by the target R-eNB or an R-RN within the target cell.

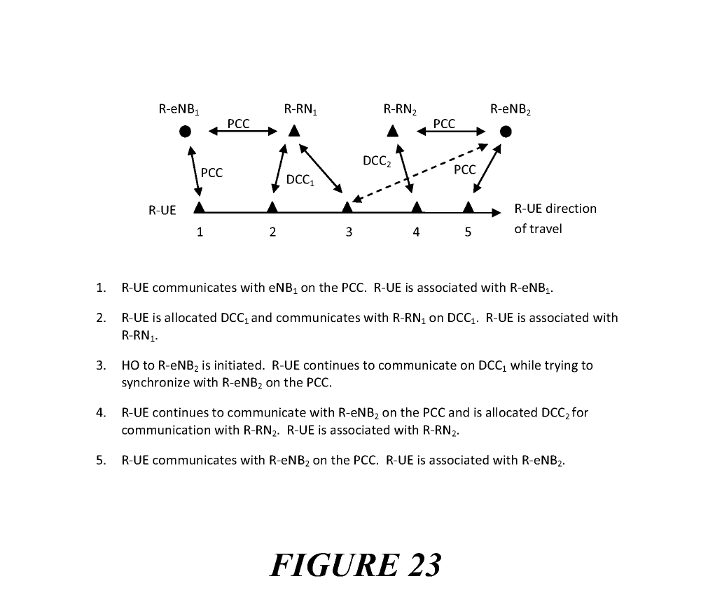

Referring to FIG. 23, an example of an R-UE handover without CoMP when the R-UE is associated with an R-RN is shown. In the case where the R-UE is associated with an R-RN without CoMP, the R-UE communicates with the source eNB (e.g., R-eNB₁) on the PCC. The R-UE is associated with the source eNB (e.g., R-eNB₁). The R-UE is allocated to DCC₁ and communicates with source R-RN (e.g., R-RN₁) on the DCC (DCC₁). The R-UE is associated with the source RN (e.g., R-RN₁). The handover to the eNB of the target cell (e.g., R-eNB₂) is initiated, the R-UE continues to communicate on DCC₁ while attempting to synchronize with the target eNB (e.g., R-eNB₂) on the PCC. The R-UE continues to communicate with the target eNB (e.g., R-eNB₂) on PCC and is allocated DCC2 for communication with the target RN (e.g., R-RN₂). The R-UE is associated with the target RN (e.g., R-RN₂). When the handover is complete, the R-UE communicates with the target eNB (e.g., R-eNB₂) on the PCC. The R-UE is associated with the target eNB (e.g., R-eNB₂).

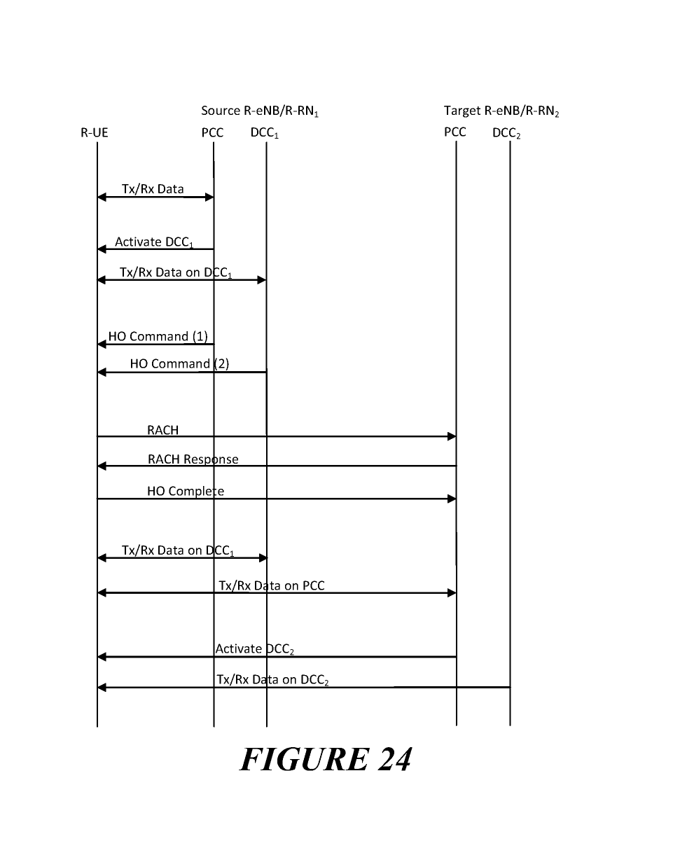

Referring to FIG. 24, a signalling diagram for the R-UE handover procedure without CoMP transmission when the R-UE is associated with the R-RN is shown. More specifically, for the case without CoMP transmission, the R-eNB issues the HO command to the R-UE on either the PCC or through the R-RN on the DCC. The R-UE synchronizes with the target R-eNB on the PCC. During this time the R-UE can communicate with the R-RN in the source cell on the DCC. Once the HO procedure is complete, the R-UE communicates with the target R-eNB on the PCC. The target R-eNB then sends a DCC allocation message to allocate a DCC that is used in the target cell. The R-UE releases the DCC from the source cell.

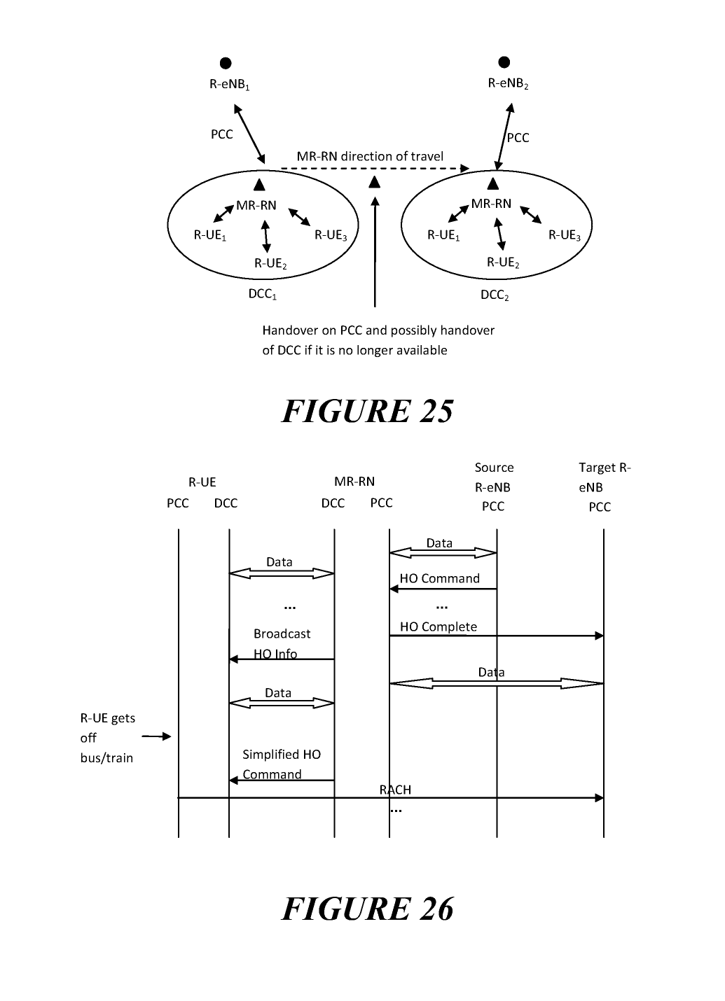

In another embodiment, support for mobile and multi-hop reconfigurable nodes is provided. Referring to FIG. 25, an example of mobile reconfigurable relay node is shown. With the case of mobile reconfigurable relay nodes, a DCC and a PCC may be assigned to a mobile reconfigurable relay node (MR-RN). The MR-RN communicates with the R-eNB on the PCC. The MR-RN receives the data for the R-UEs that are associated with it on the (DL) PCC from the R-eNB and transmits the data from the R-UEs to the R-eNB on the (UL) PCC. The R-UEs associated with the MR-RN communicate with the MR-RN on the DCC (uplink and downlink). In this case, the R-UEs do not have to maintain a connection with R-eNB on the PCC. This technique has the advantage that it reduces the number of handovers that occur as the MR-RN moves through the network coverage area. The MR-RN can perform the handover (of the PCC) as needed with the R-eNB and it can communicate the new system parameters of the PCC after the handover is complete. This allows the R-UE to easily switch to the PCC when required. For example, the MR-RN can be located on either a bus or a train. The R-UE would communicate with the MR-RN using the DCC while on the vehicle (without using the PCC). The R-UE should handover to the PCC when the R-UE gets off the bus/train.

Referring to FIG. 26, a signalling diagram for an MR-RN handover is shown. The MR-RN initially communicates with R-eNB₁ on the PCC and with the R-UEs on DCC₁. As the MR-RN moves away from the coverage area of R-eNB₁ and toward the coverage area of R-eNB₂, the MR-RN undergoes a handover on the PCC. The handover command may also include a handover of the DCC if the MR-RN is no longer available in the target cell.

When an MR-RN undergoes a handover on the PCC, the MR-RN informs the R-UEs that are associated with the MR-RN that a handover occurred on the PCC through a broadcast/multicast message on the DCC. The message may contain information such as the system information block of the target R-eNB. This handover information can facilitate the handover procedure for the R-UEs if they are required to handover to the PCC. In this way, the handover command initiated by the MR-RN to the R-UE is a simplified command that may contain only R-UE specific information such as a new C-RNTI, a dedicated RACH preamble, etc.

When the R-UE is associated with an MR-RN, the R-UE is configured to report neighbour cell measurements on the PCC. This assists the MR-RN in deciding when to issue a handover command to the R-UE to handover to the R-eNB on the PCC. Once the R-UE receives a handover command from the MR-RN, the R-UE begins to synchronize with the R-eNB on the PCC by sending a preamble on the system random access channel (RACH). The R-UE accesses the target R-eNB using a contention-free procedure if a dedicated preamble is included in the handover command. If there is no dedicated RACH preamble then the contention based procedure is used.

One benefit of using MR-RNs and DCCs rather than using Wi-Fi access (such as when traveling on the bus or train) is that the resources used by the MR-RNs are controlled by the R-eNB. No contention is required in obtaining a channel for communication with the R-UEs. A Spectrum Manager can allocate the resources to R-eNBs to allocate DCCs to MR-RNs as they are required. When the MR-RN moves to another cell, the DCCs can be released. The Spectrum Manager communicates with other nearby Spectrum Managers within the same network in the case where the DCCs are allocated from within the network operator's licensed bands or the communication can be with other Spectrum Managers from different network operators in the case where the DCCs are allocated from within a block of shared spectrum.

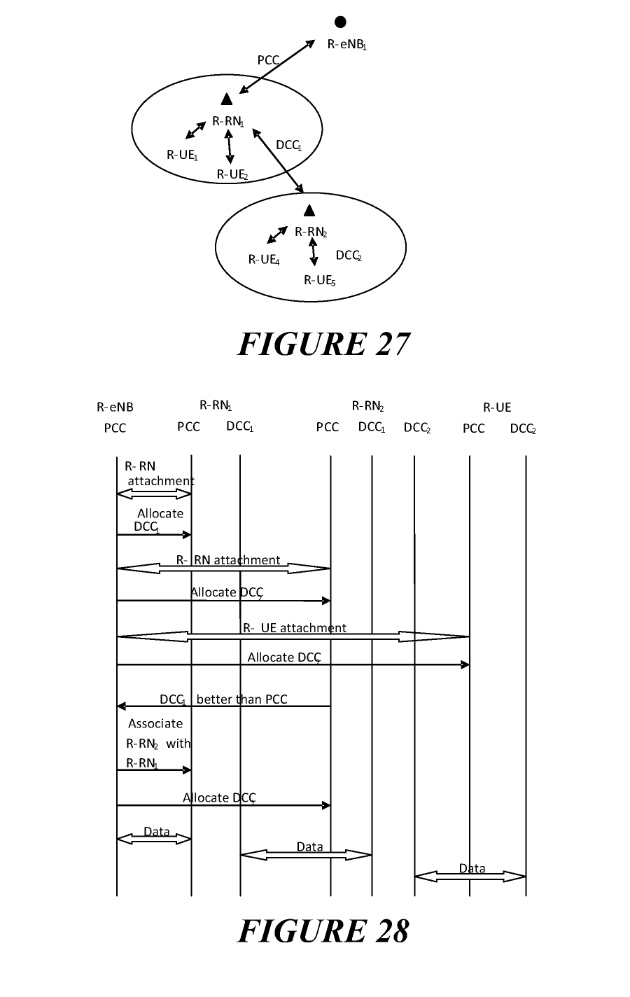

Referring to FIG. 27, a block diagram of an example of multi hop reconfigurable relay nodes is shown. For the case with multi-hop reconfigurable relay nodes, multi-hop communication among relay nodes (reconfigurable relay nodes (R-RN) or mobile reconfigurable relay nodes (MR-RN)) may be facilitated by the use of DCCs. Reconfigurable relay nodes may communicate with each other on a DCC (typically assigned by the R-eNB). With multi-hop transmission the R-eNB may transmit to one or more R- RNs. An R-RN may transmit data to another R-RN (using its assigned DCC) to extend coverage.

In the multi-hop scenario, some R-RNs may only communicate with R-UEs and other R-RNs (i.e. the R-RNs do not communicate with the R-eNB directly). In this case, an R-RN can behave as an R-eNB and allocate a DCC to another R-RN. The R-RN can allocate one of its own DCCs previously allocated by the R-eNB or it can request a new DCC from the R-eNB for allocation to the new R-RN.

In the example shown in FIG. 27, R-RN₂ reports a better channel condition to R-RN₁ on DCC₁ than to the R-eNB on the PCC. Thus, the data for R-UEs associated with R-RN₂ (e.g., R-UE₄ and R-UE₅) is routed through R-RN₁. In this case, the R-eNB sends the data to R-RN₁ on the PCC, which is then sent by R-RN₁ to R-RN₂ on DCC₁. The data is then transmitted to the R-UEs by R-RN₂ on DCC₂. FIG. 28 shows a signalling diagram of an example of multi-hop reconfigurable relay nodes.

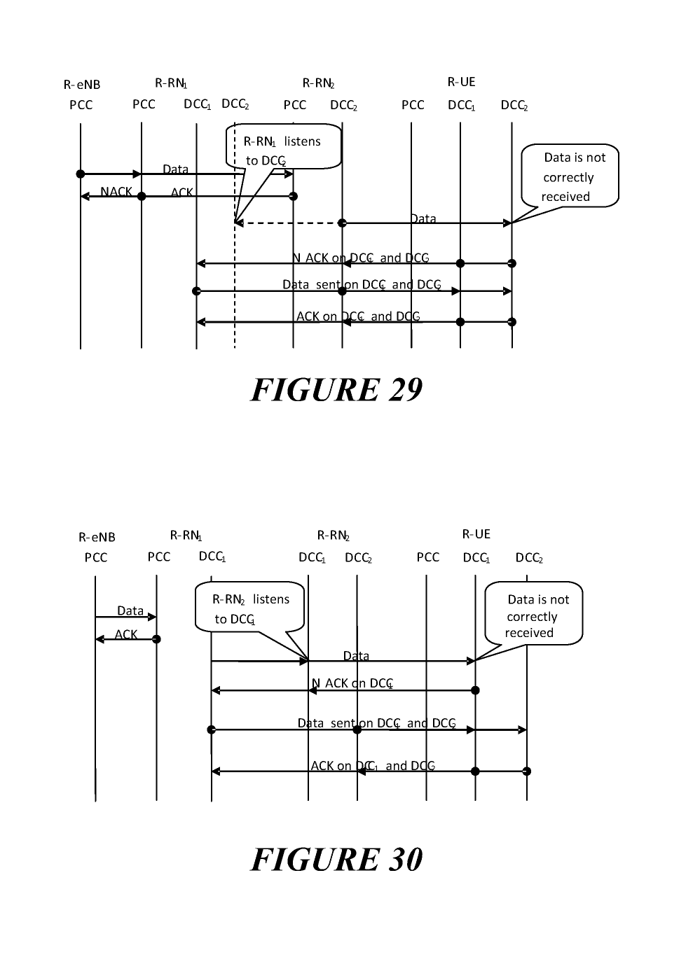

Referring to FIG. 29, a signaling diagram of an example of multi-hop transmission for assisting HARQ is shown. In the case where multi-hop transmissions are used for assisting retransmissions, multi-hop transmission with R-RN to R-RN communication can be used to assist retransmissions. In this case, the R-eNB sends data to multiple R-RNs. The R-RNs each send the data to the R-UE on a different DCC. If one of the R-RNs did not correctly receive the data, that R-RN monitors the data DL DCC from another R-RN to obtain the data. If the data is correctly received from another R-RN and no ACK is received from the R-UE, the R-RN can then assist in the retransmissions. To support this case, the R-RNs and the R-UEs receiving the data are configured for this type of transmission. The configuration information includes information such as the R-RNs/DCCs that are used for the cooperative transmission.

Referring to FIG. 30, a signaling diagram of an example of multi-hop reconfigurable relay. In an alternate embodiment, the R-eNB sends the data to one R-RN on the PCC and the R-RN sends the data to the R-UE on its allocated DCC. Another R-RN is also configured to decode the R-UE data to assist retransmissions. If a retransmission is required, the assisting R-RN can send the data on its allocated DCC. The R-UE that is configured for this type of transmission monitors the DCC of the assisting R-RN for retransmissions in addition to the R-RN that sent the first transmission.

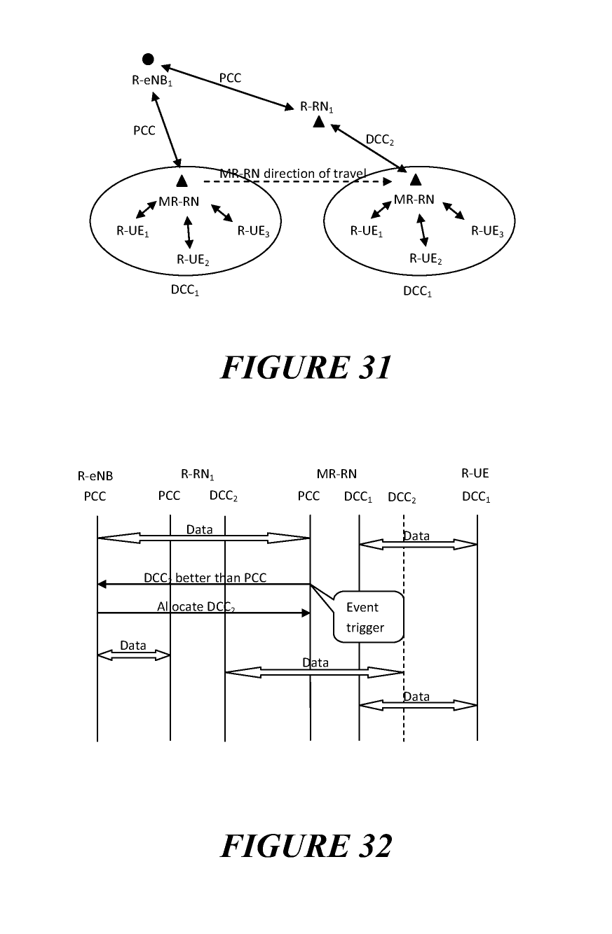

Referring to FIG. 31, a block diagram of an example of multi-hop reconfigurable relay assisting a mobile R-RN is shown. In certain embodiments, multi-hop transmission can be used to assist mobile reconfigurable relays. An MR-RN may obtain data from another R-RN on a DCC instead of directly from an R-eNB on the PCC. In this embodiment, the MR-RN initially communicates with the R-eNB on the PCC and communicates with the R-UEs associated with it on DCC₁. As the MR-RN moves closer to R-RN₁ and the channel condition to R-RN₁ on DCC₂ becomes better than the channel condition to the R-eNB on the PCC, the R-eNB allocates DCC₂ to the MR-RN. The MR-RN then receives and transmits data to the R-eNB through R-RN₂ on DCC₂. The MR-RN still maintains a connection with the R-eNB on the PCC in case it may need to handover to another cell. FIG. 32 shows a signalling diagram for the example of multi-hop reconfigurable relay with MR-RN.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

As likewise used herein, the term “node” broadly refers to a connection point, such as a redistribution point or a communication endpoint, of a communication environment, such as a network. Accordingly, such nodes refer to an active electronic device capable of sending, receiving, or forwarding information over a communications channel. Examples of such nodes include data circuit-terminating equipment (DCE), such as a modem, hub, bridge or switch, and data terminal equipment (DTE), such as a handset, a printer or a host computer (e.g., a router, workstation or server). Examples of local area network (LAN) or wide area network (WAN) nodes include computers, packet switches, cable modems, Data Subscriber Line (DSL) modems, and wireless LAN (WLAN) access points.

Examples of Internet or Intranet nodes include host computers identified by an Internet Protocol (IP) address, bridges and WLAN access points. Likewise, examples of nodes in cellular communication include base stations, base station controllers, home location registers, Gateway GPRS Support Nodes (GGSN), and Serving GPRS Support Nodes (SGSN).

Other examples of nodes include client nodes, server nodes, peer nodes and access nodes. As used herein, a client node may refer to wireless devices such as mobile telephones, smart phones, personal digital assistants (PDAs), handheld devices, portable computers, tablet computers, and similar devices or other user equipment (UE) that has telecommunications capabilities. Such client nodes may likewise refer to a mobile, wireless device, or conversely, to devices that have similar capabilities that are not generally transportable, such as desktop computers, set-top boxes, or sensors. Likewise, a server node, as used herein, refers to an information processing device (e.g., a host computer), or series of information processing devices, that perform information processing requests submitted by other nodes. As likewise used herein, a peer node may sometimes serve as client node, and at other times, a server node. In a peer-to-peer or overlay network, a node that actively routes data for other networked devices as well as itself may be referred to as a supernode.

An access node, as used herein, refers to a node that provides a client node access to a communication environment. Examples of access nodes include cellular network base stations and wireless broadband (e.g., WiFi, WiMAX, etc) access points, which provide corresponding cell and WLAN coverage areas. As used herein, a macrocell is used to generally describe a traditional cellular network cell coverage area. Such macrocells are typically found in rural areas, along highways, or in less populated areas. As likewise used herein, a microcell refers to a cellular network cell with a smaller coverage area than that of a macrocell. Such micro cells are typically used in a densely populated urban area. Likewise, as used herein, a picocell refers to a cellular network coverage area that is less than that of a microcell. An example of the coverage area of a picocell may be a large office, a shopping mall, or a train station. A femtocell, as used herein, currently refers to the smallest commonly accepted area of cellular network coverage. As an example, the coverage area of a femtocell is sufficient for homes or small offices.

As used herein, the terms “user equipment” and “UE” can refer to wireless devices such as mobile telephones, personal digital assistants (PDAs), handheld or laptop computers, and similar devices or other user agents (“UAs”) that have telecommunications capabilities. In some embodiments, a UE may refer to a mobile device. The term “UE” may also refer to devices that have similar capabilities but that are not generally transportable, such as desktop computers, set-top boxes, or network nodes.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope or spirit of the claimed subject matter.

The word “exemplary” is used herein to mean serving as an example, instance, or illustration. Any aspect or design described herein as “exemplary” is not necessarily to be construed as preferred or advantageous over other aspects or designs. Those of skill in the art will recognize many modifications may be made to this configuration without departing from the scope, spirit or intent of the claimed subject matter. Furthermore, the disclosed subject matter may be implemented as a system, method, apparatus, or article of manufacture using standard programming and engineering techniques to produce software, firmware, hardware, or any combination thereof to control a computer or processor-based device to implement aspects detailed herein.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made without departing from the spirit and scope disclosed herein. Although the present invention has been described in detail, it should be understood that various changes, substitutions and alterations can be made hereto without departing from the spirit and scope of the invention as defined by the appended claims.

What is claimed is:

1. A method for extending carrier aggregation (CA) to facilitate management of a plurality of component carriers, the method comprising:
assigning a dynamic component carrier (DCC) to a first communication node;
communicating between the first communication node and a second communication node via the DCC within at least one mobile communications network.

2. The method of claim 1 wherein:
the second communication nodes comprise a reconfigurable node, the reconfigurable node comprising at least one of a reconfigurable E-UTRAN (evolved universal terrestrial radio access network) node B (eNB), a reconfigurable Relay Node (R-RN), a reconfigurable user equipment (R-UE), and a reconfigurable Home eNB (R-HeNB).

3. The method of claim 1 wherein:
the assigning further comprises dynamically assigning dynamic component carriers for the second communication node from existing spectrum bands that are using different RATs and that are available to the first communications node.

4. The method of claim 1 wherein:
the assigning further comprises dynamically assigning dynamic component carriers for the second communication nodes from spectrum available for use by the communication nodes.

5. The method of claim 1 wherein:
carrier aggregation (CA) and self-organized network (SON) procedures are extended to enable cognitive radio (CR) and dynamic spectrum access (DSA) techniques to improve spectrum utilization.

6. The method of claim 5 wherein:
extending the CA and SON procedures enables dynamic allocation of non-legacy component carriers to different nodes within a network of an operator, opportunistic use of white space within licensed bands of an operator; and, opportunistic allocation of available channels within shared spectrum and other dynamically available channels.

7. An apparatus for dynamically assigning dynamic component carriers within a context of a mobile communications network comprising:
a radio resource dynamic assignment system, the radio resource dynamic assignment system assigning dynamic component carriers to multiple communication nodes within at least one mobile communications network.

8. The apparatus of claim 7 wherein:
the communication nodes comprise reconfigurable nodes, the reconfigurable nodes comprising at least one of reconfigurable eNBs, reconfigurable Relay Nodes (RNs), a reconfigurable user equipment (UE), and reconfigurable Home eNBs (HeNBs).

9. The apparatus of claim 7 wherein:
the assigning further comprises dynamically assigning dynamic component carriers for the communication nodes from existing spectrum bands that are using different RATs and that are available to the first communications node.

10. The apparatus of claim 7 wherein:
the assigning further comprises dynamically assigning dynamic component carriers for the communication nodes from a spectrum available for use by the communication nodes.

11. The apparatus of claim 7 wherein:
carrier aggregation (CA) and self-organized network (SON) procedures are extended to enable cognitive radio (CR) and dynamic spectrum access (DSA) techniques to improve spectrum utilization.

12. The apparatus of claim 11 wherein:
extending the CA and SON procedures enables dynamic allocation of fixed, non-legacy component carriers to different nodes within a network of an operator, opportunistic use of white space within licensed bands of an operator; and, opportunistic allocation of available channels within shared spectrum and other dynamically available channels.
